(19) United States
(12) Patent Application Publication
(10) Pub. No.: US 2015/0234765 A1
(43) Pub. Date: Aug. 20, 2015

(54) INTERACTING WITH HARDWARE INTERFACES OF END DEVICES USING PATH SELECTORS

(71) Applicant: Lorin Kline, San Francisco, CA (US)

(72) Inventor: Lorin Kline, San Francisco, CA (US)

(73) Assignee: AliphCom, San Francisco, CA (US)

(21) Appl. No.: 14/183,493

(22) Filed: Feb. 18, 2014

(51) Int. Cl. G06F 13/40; G06F 13/42

(52) U.S. Cl. CPC G06F 13/4022; G06F 13/4221

(57) ABSTRACT

Techniques for interacting with hardware interfaces of end devices using a hardware interface selector having a path selector and a controller are described. Path selectors may be configured to be coupled to a mechanical switch, a battery, a memory, a connector or other hardware interface of an end device. The controller may be configured to generate control signals to cause a closing of the path selectors. Control signals may be configured to generate an electrical signal representing a closing of the mechanical switch, configured to cause detection of an analog signal representing a level of the battery, or configured to cause retrieval of data representing a state of the end device from the memory. The controller may determine whether an end device is functioning properly based on the level of battery, state of the end device, or other response data signals.

### FIELD

Various embodiments relate generally to electrical and electronic hardware, circuitry, computer software, human-computing interfaces, wired and wireless network communications, data processing, and computing devices. More specifically, disclosed are techniques for interfacing with hardware devices using path selectors.

### BACKGROUND

Peripheral computing devices or end devices generally have hardware interfaces with host devices and end users. One common hardware interface with a host device is a Universal Serial Bus (USB) connector or port. Other connectors or ports, e.g., serial ports, parallel ports, external SATA ports, Internet ports, Ethernet ports, audio ports, display ports, HDMI ports, etc., may also be used. Common hardware interfaces with end users include buttons, sliders, toggle switches, flip switches, momentary switches, other switches and the like. Further, certain flags or data representing a status of an end device, such as a level of the battery of the end device, data stored on a memory of an end device, etc., may be inaccessible by a connector or port, such as a USB connector, of the end device.

Generally, a human being interacts with the hardware interfaces of end devices, e.g., by connecting the USB connector to a host device, by pressing buttons, by connecting wires to a battery, etc. In certain testing environments, such as during prototyping or production, many end devices may need to be tested at once, and manual interaction with the hardware interfaces of these end devices may need to be manually executed. Further, if an end user is physically disabled, he may be unable to manually connect or press buttons of end devices.

Conventional devices, e.g., USB hubs, generally allow multiple end devices to be connected to a host device. However, the number of end devices to be connected to a host device is generally limited. Moreover, conventional devices do not allow switching from one end device to another, or severing or disconnecting an end device from the host device.

Thus, what is needed is a solution for interfacing with hardware end devices without the limitations of conventional techniques.

### BRIEF DESCRIPTION OF THE DRAWINGS

Various embodiments or examples (“examples”) are disclosed in the following detailed description and the accompanying drawings:

FIG. 1A illustrates an exemplary hardware interface selector with host devices and end devices in some applications, according to some examples;

FIG. 1B illustrates a block diagram of an exemplary hardware interface selector in some applications, according to some examples;

FIG. 2 illustrates an application of an exemplary hardware interface selector with a host device and end devices in some applications, according to some examples;

FIG. 3 illustrates an application of an exemplary hardware interface selector with host devices and an end device in some applications, according to some examples;

FIG. 4 illustrates a block diagram of an exemplary hardware interface selector with a host device and end devices, according to some examples;

FIG. 5 illustrates another block diagram of an exemplary hardware interface selector with a host device and end devices, according to some examples;

FIG. 6 illustrates another block diagram of an exemplary hardware interface selector with a host device and end devices, according to some examples;

FIG. 7 illustrates a block diagram of an exemplary controller configured to be used in an exemplary hardware interface selector, according to some examples;

FIG. 8 illustrates applications of an exemplary hardware interface selector, according to some examples;

FIG. 9 illustrates an application of an exemplary hardware interface selector with a host device and end devices in some applications, according to some examples;

FIG. 10 illustrates an application of an exemplary hardware interface selector with host devices and end devices in some applications, according to some examples;

FIG. 11 illustrates a block diagram of an exemplary hardware interface selector with a host device and end devices, according to some examples;

FIG. 12 illustrates an application of an exemplary hardware interface selector with host devices and an end device in some applications, according to some examples;

FIG. 13A-C illustrates an application of an exemplary hardware interface selector with an end device in some applications, according to some examples;

FIG. 14 illustrates an exemplary process for a hardware interface selector, according to some examples;

FIG. 15 illustrates another exemplary process for a hardware interface selector, according to some examples;

FIG. 16 illustrates another exemplary process for a hardware interface selector, according to some examples;

FIG. 17 illustrates another exemplary process for a hardware interface selector, according to some examples;

FIG. 18 illustrates another exemplary process for a hardware interface selector, according to some examples; and

FIG. 19 illustrates an exemplary computing platform of an exemplary hardware interface selector in some applications, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

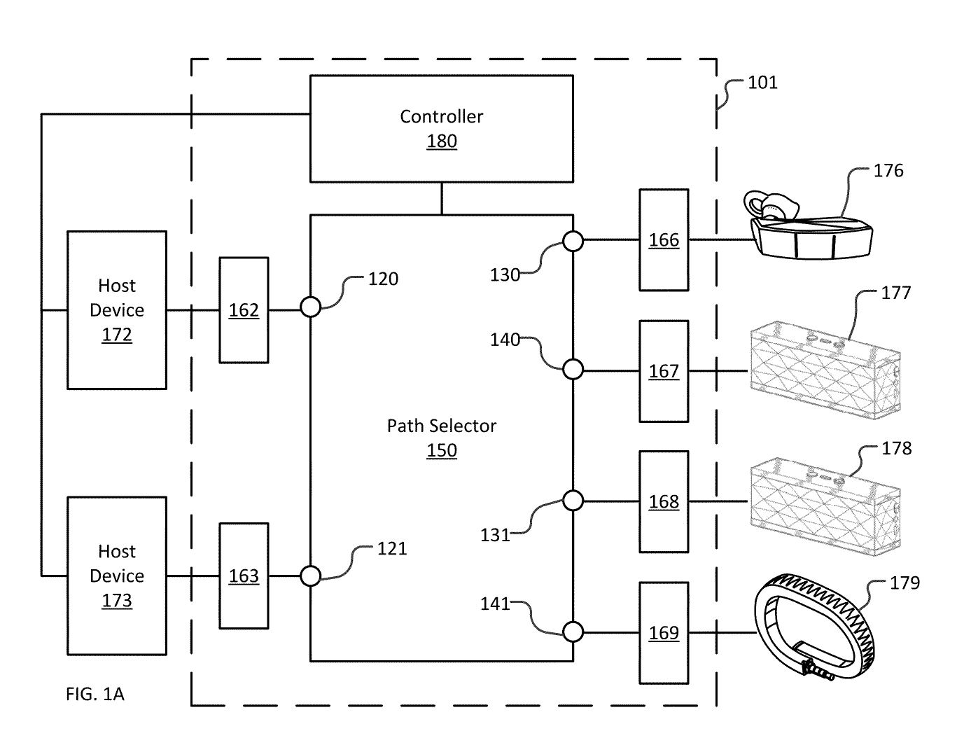

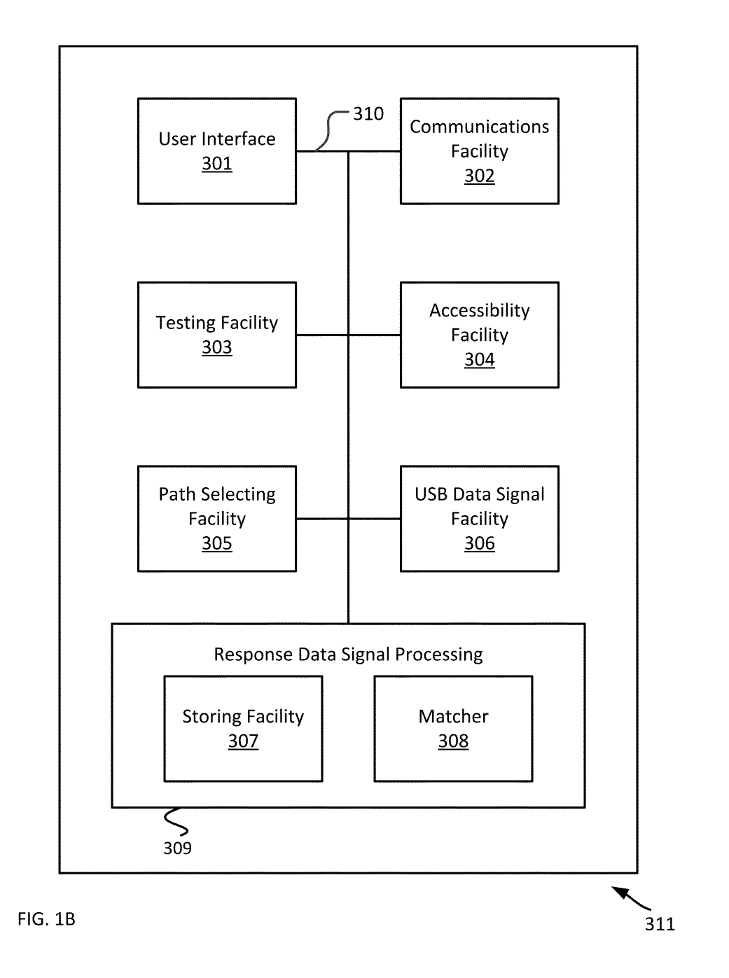

FIG. 1A illustrates an exemplary hardware interface selector with host devices and end devices in some applications, according to some examples. Here, a hardware interface selector 101 includes a path selector 150, connectors 162-169, contacts 120, 130 and 140, and a controller 180. Hardware interface selector 101 may be coupled to host devices 172-173 and end devices 176-179. In some examples, path selector 150 may be configured to route data between a first subset of contacts 120 and a second subset of contacts 130 based on a first control signal, to route data between a third subset of contacts 121 and a fourth subset of contacts 131 based on a second control signal, to sever data communication between the first subset of contacts 120 and the second subset of contacts 130 based on a third control signal, and to sever data communication between the third subset of contacts 121 and the fourth subset of contacts 131 based on a fourth control signal. A first connector 162, e.g., a first USB connector or other hardware interface, may be coupled to the first subset contacts 120, and the first connector 162 may be configured to exchange a first data signal, e.g., a first USB-formatted data signal, with a first host device 172. The first data signal may be formatted based on USB protocols, serial port protocols, parallel port protocols, audio port protocols, or other protocols. The first data signal may cause execution of an operation of end devices 176-179. A second connector 166, e.g., a second USB connector, may be coupled to the first subset of contacts 130, and the second connector 166 may be configured to exchange the first data signal, e.g., the first USB-formatted data signal, with a first end device 176. A third connector 163, e.g., a third USB connector, may be coupled to the third subset of contacts 121, and the third connector 163 may be configured to exchange a second data signal, e.g., a second USB-formatted data signal, with a second host device 173. A fourth connector 168, e.g., a fourth USB connector, may be coupled to the fourth subset of contacts 131, and the fourth connector 168 may be configured to exchange the second data signal, e.g., the second USB-formatted data signal, with a second end device 178. A controller 180 may be configured to generate the first control signal to cause the first host device 172 to detect an attachment of the first end device 176, to generate the second control signal to cause the second host device 173 to detect an attachment of the second end device 178, to generate the third control to cause the first host device 172 to detect a detachment of the first end device 176, and to generate the fourth control signal to cause the second host device 173 to detect a detachment of the second end device 178.

In one example, path selector 150 may further be configured to route data between the first subset of contacts 120 and a fifth subset of contacts 140 based on the third control signal, to route data between the third subset of contacts 121 and a sixth subset of contacts 141 based on the fourth control signal, to sever data communication between the first subset of contacts 120 and the fifth subset of contacts 140 based on the first control signal, and to sever data communication between the third subset of contacts 121 and the sixth subset of contacts 141 based on the second control signal. A fifth connector 167, e.g., a fifth USB connector, may be coupled to the fifth subset of contacts 140, and the fifth connector 167 may be configured to exchange a third data signal, e.g., a third USB-formatted data signal, with the fifth end device 177. A sixth connector 169, e.g., a sixth USB connector, may be coupled to the sixth subset of contacts 141, and the sixth connector 169 may be configured to exchange a fourth data signal, e.g., a fourth USB-formatted data signal, with the sixth end device 179. Controller 180 may be configured to generate the first control signal to cause the first host device 172 to detect an attachment of the first end device 176 and a detachment of the fifth end device 177, to generate the second control signal to cause the second host device 173 to detect an attachment of the second end device 178 and a detachment of the sixth end device 179, to generate the third control signal to cause the first host device 172 to detect a detachment of the first end device 176 and an attachment of the fifth end device 177, and to generate a fourth control signal to cause the second host device 173 to detect a detachment of the second end device 178 and an attachment of the sixth end device 179. Other implementations of hardware interface selector 101 may also be possible

A host device (e.g., host devices 172-173) may be a computer or computing device that provides data signals and control signals to an end device (e.g., end devices 176-179) and receives data signals and control signals from the end device. A host device may interact or exchange data with an end device, such as detecting the attachment or detachment of an end device, managing control flow between the host device and the end device, managing data flow between the host device and the end device, collecting status and activity statistics, providing power to the end device, and the like. A host device may also manage, control or facilitate interactions or data communications between the host device and the end device, such as enumerating and configuring an end device, handling isochronous or asynchronous data transfers, managing power, managing the end device and a bus handling the data communications, and the like. Enumerating an end device may include assigning or giving the end device an address (e.g., a USB address) or other identifier or ID. When attachment of an end device is detected by the host device, the host device may enumerate or assign an address to the end device. When detachment of an end device is detected by the host device, the end device may be reset or reconfigured. When attachment of an end device is detected by the host device again, the host device may renumerate the end device, e.g., assign an address to the end device that is the same as or different from the first time the end device was attached. The attachment and detachment of the end device may be a method for hot swapping or hot plugging end devices, e.g., replacing components, end devices, or peripheral devices without shutting down a computer system. A host device may run on a number of different types of operating systems, such as iOS, OS X or Mac OS X developed by Apple Inc. of Cupertino, Calif., Linux or GNU/Linux, Android and Chromium OS developed by Google Inc. of Menlo Park, Calif., Microsoft Windows developed by Microsoft Corporation of Redmond, Wash., and the like.

An end device may have hardware that is separate from the host device, and may or may not have an operating system, system software, configurable logic, etc. In some examples, certain flags or data representing a status of the end device may be inaccessible by a connector or port of the end device. An end device may provide a specific category of functionalities, or it may expand the functionalities or capabilities of the host device. Installation or execution of operations, software, applications or executable instructions of an end device may be caused or triggered by a host device, wherein the host device detects the attachment of the end device. An end device may be reset, e.g., reverts to original software or applications, cancels an operation, resets to a default setting, etc., when the host device detects the detachment of the end device. Examples of end devices include a speaker, speaker box or media device (e.g., end devices 177-178), a headset (e.g., end device 176), a data-capable strapband (e.g., end device 179), a wearable device, a smartphone, a microphone, a webcam, an external memory, and others. An example of a suitable wearable device or data-capable strapband (e.g., end device 179), or a variant thereof, is described in U.S. patent application Ser. No. 13/454,040, which is incorporated herein by reference. In some examples, a speaker box (e.g., end devices 177-178) may be implemented as a media device, such as the JAMBOX™, or equivalent, developed by AliphCom of San Francisco, Calif., an equivalent thereof, or any variant thereof. One device may function as a host device in one context and as an end device in another context. One host device may be coupled to one or more end devices, and one end device may be coupled to one or more host devices. Other implementations of a host device and an end device are also possible, and an unlimited number of host devices and end devices may be coupled to the hardware interface selector.

A connector (e.g., connectors 162-169) may be a physical connector, port or hardware interface between a host device and an end device. Examples of connectors include a Universal Serial Bus (USB) connector, a serial port, a parallel port, an external SATA port, an Internet port, an Ethernet port, an audio port, a display port, an HDMI ports, and others. A connector may be a plug or a receptacle. A plug or a male connector may be inserted or otherwise connected with a receptacle or female connector. For example, a receptacle may be installed, manufactured, fabricated on or otherwise coupled to a host device, and another receptacle may be installed, manufactured, fabricated on or otherwise coupled to an end device. A cable having plugs on both ends may be used to connect the host device and the end device. As another example, a receptacle may be coupled to a hardware interface selector (e.g., hardware interface selector 101). The cable may be used to connect a host device and the hardware interface selector, or to connect an end device and the hardware interface selector.

USB is an industry standard that defines cables, connectors and communication protocols for connecting, exchanging or communicating data, and supplying power between a host device and an end device. USB includes a number of variants, including standard size USB, mini USB, micro USB, versatile or “on the go” USB, and others. USB also includes a number of data transfer speeds, including low speed, full speed, high speed, superspeed, and others. USB also includes a number of versions and revisions, including USB 1.x, USB 2.0, USB 3.0, USB 3.1, and others. USB transfers signal and power over a number of terminals, wires or pins of a cable. In one example, a four-wire cable is used, with a pair of wires for transferring data, and another pair for connecting to voltage supply and ground. In another example, a USB cable has eight primary wires, six wires (three pairs) for data paths and two wires for voltage supply and ground. The specifications of each USB version, variant or other implementation, maintained by USB Implementers Forum, Inc. of the State or Oregon, are hereby incorporated by reference in their entirety.

A controller (e.g., controller 180) may be one or more processors, microprocessors, and/or microcontrollers configured to control a hardware interface selector. A controller may send control signals to one or more path selectors (e.g., path selector 150) to route data along one or more paths between one or more host devices and one or more end devices. A host device may be connected to multiple end devices sequentially (e.g., connected to a first end device, and then to a second end device) or simultaneously (e.g., connected to a first end device and a second end device at substantially the same time). The controller may also send control signals to one or more host devices to command, instruct or cause the host device to execute an operation associated with an end device, e.g., initiating transmission of a signal to an end device, receiving and analyzing a signal from an end device, enumerating or configuring an end device, managing control flow between the host device and the end device, managing data flow between the host device and the end device, collecting status and activity statistics, providing power to the end device, and the like. A controller may also receive data from a host device or an end device, and may store the data in a memory coupled to the controller. A controller may further analyze the data and present information associated with the data on a user interface.

A path selector (e.g., path selector 150) may comprise a plurality of contacts and may be configured to route data between one contact and another contact. The data routing or communication may be unidirectional or bidirectional. A contact may be a physical node of a path selector or switch configured to be connected or coupled to another device, such as a connector, a host device, an end device, another path selector, a controller, etc. In one example, a path selector may include one or more switches configured to connect a first subset of contacts and a second subset of contacts, and the one or more switches may be coupled to a relay board configured to receive a control signal from a controller. A switch may be configured to be set to different positions or settings. In one example, a switch may have a pole contact and a throw contact, each configured to be coupled to a different device. A closing or closed position of the switch may connect or couple the pole contact and the throw contact. An open position may disconnect the pole contact and the throw contact. In another example, one position of the switch may connect or provide a closed path for the pole contact and a first throw contact, and another position may connect the pole contact and a second throw contact while severing or disconnecting the pole contact and the first throw contact. A closed path between two contacts may be an electrically conducting path between the two contacts. The electrically conducting path may be caused by a physical connection between the two contacts, or switching of a transistor or logic gate, or other methods. A path selector may select or sever paths based on a control input. The control input may be a digital or analog signal, such as a voltage signal, e.g., 5 V signal, a current signal, and the like. One signal, e.g., a 0 V signal, may indicate one position of the switch, e.g., severing the path between two contacts. Another signal, e.g., a 5 V signal, may indicate another of the switch, e.g., connecting or coupling the two contacts.

FIG. 1B illustrates a block diagram of an exemplary hardware interface selector in some applications, according to some examples. Here, a controller 311 of a hardware interface selector (not shown) includes user interface 301, communications facility 302, testing facility 303, accessibility facility 304, path selecting facility 305, USB data signal facility 306, response data signal processing 309, and bus 310. Response data signal processing 309 includes storing facility 307 and matcher 308. As used herein, “facility” refers to any, some or all of the features and structures that are used to implement a given set of functions. Elements 301-309 may be fabricated, manufactured or implemented on the same device (as shown) or on different devices. Elements 301-309 may be implemented in hardware, software, firmware, or other methods.

User interface 301 may be configured to input or output data to and from an end user. User interface 301 may be implemented as a touchscreen, keyboard, mouse, joystick, LED light, display screen, speaker, microphone, or other device used to serve as an interface between controller 311 and the user. For example, a user may enter a command signal using a mouse to select a testing application or other operation to be executed on an end device using testing facility 303. As another example, a user may enter a command signal using a keyboard to perform an analysis on response data signals using response data signal processing 309. As another example, a user with a disability may provide an alternate command signal using user interface 301 to execute an operation of the end device. An alternate command signal may be used in lieu of a user interaction with a connector, mechanical switch or other interface of an end device to execute the desired operation. Still other usages of the user interface may be possible.

Communications facility 302 may be configured to transmit, receive, or exchange data with controller 311. Data received or saved at a remote or external device may be communicated through a network with communications facility 302. For example, communications facility 986 may include a wireless radio, control circuit or logic, antenna, transceiver, receiver, transmitter, resistors, diodes, transistors or other elements that are used to transmit or receive data to and from controller 980. In some examples, communications facility 986 may be implemented to provide a wired data communication capability such as an analog or digital attachment, plug, jack, land line or the like to allow for data to be transferred. In other examples, communications facility 986 may be implemented to provide wireless data communication capability to transmit digitally encoded data across one or more frequencies using various types of data communication protocols, without limitation. For example, a user at a remote location may use a touchscreen of a smartphone to select a command, operation, testing application or build to be implemented on a host device or an end device. In some examples, an end user may be disabled, and an assistant of the end user may input a command on a device in data communication with controller 311. In some examples, elements 303-309 may be remote from controller 311, and communications facility 981 may be used to transmit and receive data between controller 311 and elements 303-309.

Testing facility 303 may be configured to generate, store, implement or execute testing or other applications, operations or builds. A build may be used to refer to an application, program, set of executable instructions, software, firmware, hardware, circuitry, or operating system associated with a host device or an end device. A build may have an identifier to distinguish between different versions or types of builds, for example, applications may be identified as Software #m and Software #n, hardware components may be identified as Hardware #p and Hardware #q, etc. Various tests or operations may be executed on various end devices with different builds. In one example, a testing application may install, execute, modify, or update a program or set of executable instructions on an end device, e.g., installing a noise cancellation feature on a media device, installing firmware that updates the range of the volume setting of a media device from seventeen to twenty, etc. In another example, a testing application may execute an operation of the end device, e.g., turn off the device, raise the volume of an audio signal generated by a media box, etc. Applications or operations used by testing facility 303 may be pre-installed, generated, created or modified.

Accessibility facility 304 may be configured to generate, store, implement or execute accessibility applications or other operations on a host device or an end device. Accessibility applications may be configured to receive an alternate command signal in lieu of a user interaction with a mechanical switch, connector or hardware interface of an end device to execute an operation of the end device. In one example, an accessibility application may receive information identifying or describing a disability of an end user. The information on the disability of the end user may be entered using user interface 301 or received at communications facility 302, or may be received using other methods. Based on the disability, the accessibility application may determine one or more alternate command signals associated with the disability, e.g., one or more alternate command signals that may be performed by an end user having the disability, or one or more alternate command signals to execute an operation of an end device that would otherwise be difficult or impossible for the end user to execute using the hardware interface of the end device due to her disability. For example, a person with a loss of vision may be unable to see and press a mechanical switch on the surface of an end device. The mechanical switch may be configured to raise the play an audio file when pressed. An alternate command signal may be an audio or voice command, such as, “Play the audio file.” Thus, the audio file may be played using the voice command without pressing the mechanical switch. As another example, a person with a physical immobility, such as the inability to move an arm, leg, etc., may be unable to connect or plug in the connectors of an end device to a host device, but he may be able to press a button on a remote device near his wheelchair. An alternate command signal may be a compression of the button. The button may cause the hardware interface selector to route data between the host device and the end device, wherein the hardware interface selector may be coupled to the host device and the end device. The data routing may cause the host device to detect an attachment of the end device. As another example, a person with a physical immobility may be unable to detach an end device from a host device. An alternate command signal may be a voice command, “Detach the end device from the host device.” The voice command may cause the hardware interface selector to sever data communication between the end device and the host device, causing the host device to detect a detachment of the end device.

Path selecting facility 305 may be configured to generate a control signal to select a path for routing data or for severing data communication using a path selector. A control signal for selecting or severing a path may be a digital signal having a series of digits or characters. Each digit in the series may correspond to one path selector or switch, or to a group of path selectors or switches. For example, the first digit may correspond to the first path selector, the second digit to the second path selector, and so on. As another example, the first digit may correspond to the first four path selectors, the second digit to the next four path selectors, and so on. The control signal may cause transmission of a control input to a path selector or switch, such as a voltage signal, e.g., a 5 V signal, a current signal, or the like. Based on the control input, the path selector connects or severs a path. As an example, a control signal may be “01,” wherein “0” indicates connecting the “top path” and “1” indicates selecting a bottom path. Referring to FIG. 1, for example, the first digit of the control signal may correspond to a first switch having contacts 120, 130 and 140, and “0” may indicate connecting the top path, e.g., the path having contacts 120 and 130. The second digit may correspond to a second switch having contacts 121, 131 and 141, and the “1” may indicate connecting the bottom path, e.g., the path having contacts 121 and 141. Still, other implementations may be possible.

USB data signal facility 306 may be configured to generate a control signal to a host device to cause the host device to transmit a data signal, e.g., a USB-formatted data signal, to an end device. Other formats may be used by the data, for example a serial port protocol, an audio port protocol, etc. A data signal may be configured to execute an operation of the end device, and the operation may be determined by the testing facility 303 or the accessibility facility 304. For example, a USB-formatted data signal may be an instruction to install software on an end device. As another example, the USB-formatted data signal may be an instruction to perform an operation of an end device. Path selecting facility 305 and USB data signal facility 306 may synchronize the generation of a first control signal for selecting a path coupled to a host device and the end device, and the generation of a second control signal for causing the host device to transmit the data signal to the end device in such a way that the first control signal and the second control signal are generated substantially simultaneously. Referring to FIG. 1, for example, as the first control signal selects the path connecting host device 172 and end device 176, the second control signal causes transmission of a data signal from host device 172 to end device 176.

Response data signal processing 309 may be configured to receive, process, and analyze a response data signal. A response data signal may represent a status of a host device or an end device after execution of an operation. The operation may be an enumeration of an end device, installation of an application, adjustment of a setting of an end device, e.g., turning off the end device, raising the volume on the end device, etc., and the like. For example, after installation of an application, a response data signal may indicate that the installation was complete. For example, after installation of an application to modifies the range of the volume setting of an end device from seventeen to twenty four, a response data signal may indicate the range of the volume setting is twenty four. For example, after enumeration of an end device, a response data signal may indicate that enumeration is complete, or may indicate an address, e.g., a USB address, of the end device. A response data signal may be generated by a host device or an end device. A response data signal may be received directly or indirectly from the host device or the end device. For example, a response data signal generated by an end device may be received by the hardware interface selector, routed by the hardware interface selector to the host device, and transmitted by the host device to controller 311.

Storing facility 307 may be configured to store the response data signal in a test repository or other memory. In one example, a parameter of an end device may be received by user interface 301. A parameter may be associated with software or hardware of the end device, an employee or entity involved with designing, making, testing, or using the end device, a functional or aesthetic aspect of the end device, a build identifier or version number of the end device, etc. For example, a parameter may be a manufacturer of the end device. Storing facility 307 may associate a first response data signal from a first end device with a first manufacturer, and associate a second response data signal from a second end device with a second manufacturer. Storing facility 307 may store a database or table of response data signals and associated parameters.

Matcher 308 may be configured to determine whether a host device or an end device is functioning properly based on a response data signal. For example, a response data signal may indicate that installation of software was complete. Matcher 308 may determine that end device is functioning properly based on this response data signal. As another example, matcher 308 may have a memory storing one or more expected values or templates of response data signals. An expected value may be associated with an application or operation used by testing facility 303 or accessibility facility 304. The expected value may be an expected value of a status of an end device after performance of the operation. For example, after installing software changing the range of the volume setting from seventeen to twenty-four, the expected value of the range of the volume setting is twenty-four. Matcher 308 may compare the response data signal received from an end device with one or more expected values. If there is a “match” or the response data signal is substantially the same as an expected value, e.g., the response data signal indicates twenty-four, then matcher 308 determines that the end device is “functioning properly.” As another example, the match between the response data signal and the expected value may be within a certain tolerance. An application may increase the volume of low frequency audio signals produced by a media device and decrease the volume of high frequency audio signals. Matcher 308 may store an expected output from the media device associated with the application and a test audio file. The response data signal may be an output in response to the test audio file from media device after installing the application. Matcher 308 may compare the output with the expected output and determine that the media device is functioning properly if the match is within a certain tolerance. As another example, controller 311 may receive an alternate command signal to raise the volume of an audio signal produced by a media device. A response data signal may indicate the value of the volume setting on the media device. Matcher 308 may determine whether the end device is functioning properly, e.g., the volume has been raised, based on the response data signal.

Matcher 308 may further be configured to determine a relationship or statistical information associated with a response data signal. For example, matcher 308 may determine that response data signals from 89% of the end devices tested are substantially similar. As another example, matcher 308 may determine that response data signals from 75% of the end devices tested match or are substantially similar to expected values. As another example, matcher 308 may determine a relationship associated with a response data signal and a parameter of the end device. For example, matcher 308 may determine that 60% of end devices manufactured by a first company are functioning properly, while 80% of end devices manufactured by a second company are functioning properly.

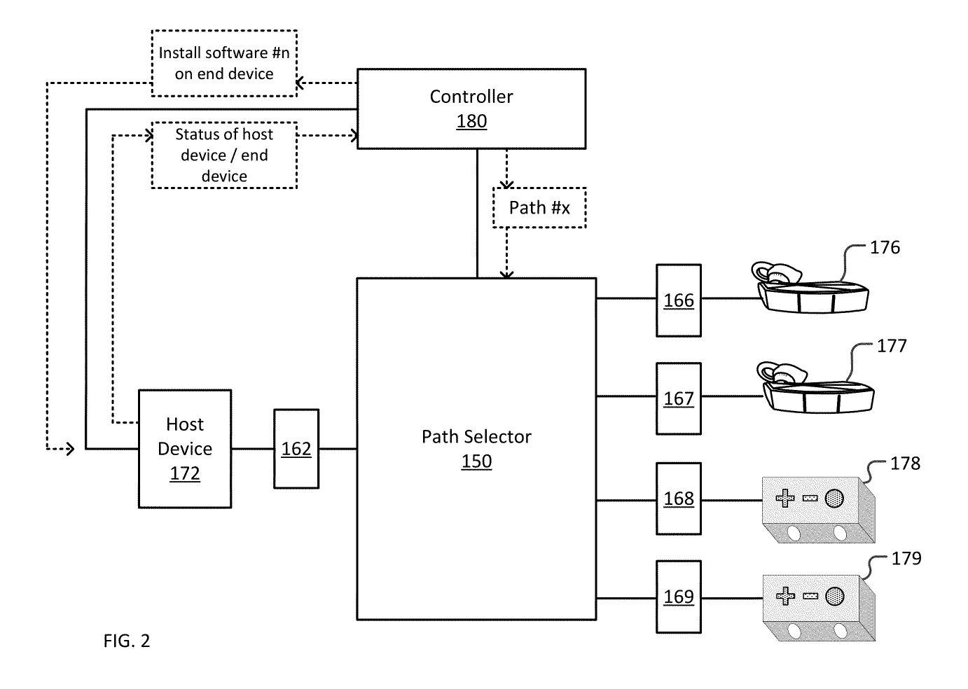

FIG. 2 illustrates an application of an exemplary hardware interface selector with a host device and end devices in some applications, according to some examples. Similarly-named and/or similarly-numbered elements shown in FIG. 1A may at least include similar or equivalent structures and/or functions. Here, a hardware interface selector (not shown) may include a path selector 150, connectors 162-169, and a controller 180. As shown, controller 180 may be coupled to path selector 150 and a host device 172. Path selector 150 may be coupled to connectors 162-169. Connectors 162-169 may be coupled to host device 172 and end devices 176-179, and connectors 162-169 may be USB connectors or other connectors or hardware interfaces. Path selector 150 may be configured to route data between connector 162 and connectors 166-169 using a number of paths, e.g., Path #w, Path #x, Path #y, Path #z, etc. Path #w may route data between connector 162 and connector 166. Path #x may route data between connector 162 and connector 167. Path #y may route data between connector 162 and connector 168. Path #z may route data between connector 162 and connector 169. Multiple paths may be connected or used simultaneously or consecutively.

In one example, as shown, controller 180 may generate a first control signal to route data using “Path #x.” Controller 180 may further generate a second control signal to host device 172 to install software on end device 177. The new software may be selected from a plurality of applications or software versions, e.g., Software #m, Software #n, etc. As shown, the second control signal may cause host device 172 to install Software #n to end device 177. Host device 172 may transmit a data signal, e.g., a USB-formatted data signal, to be received by end device 177, instructing or causing end device 177 to install Software #n. Connector 162 may be coupled to host device 172 and may receive the USB-formatted data signal, and then path selector 150 may receive the USB-formatted data signal. Path selector 150 may route the USB-formatted data signal to connector 167 based on the first control signal, forming a connection between connector 162 and connector 167. Connector 167 may be coupled to end device 177 and may cause transmission of the USB-formatted data signal to end device 177. Thus, the hardware interface selector may select one or more of end devices 176-179 to interface with host device 172. Still other implementations may be possible.

In one example, as shown, controller 180 may receive a response data signal or a data representing a status of host device 172 and end device 177. In one example, host device 172 or end device 177 may initiate transmission of the response data signal following the completion of the installation of Software #n. A response data signal transmitted from end device 177 may be received at connector 167 and routed to connector 162 using Path #x based on the first control signal or another control signal generated by controller 180. Host device 172 may receive the response data signal and transmit the response data signal to controller 180. In another example, host device 172 may send another control signal (not shown) prompting end device 177 to transmit the response data signal. In another example, controller 180 may send another control signal (not shown) to host device 172, prompting end device 177 to transmit the response data signal. The response data signal may include data representing that the installation of Software #n was successful, data representing a level of a battery of end device 177 after the installation of Software #n, a setting (e.g., a volume setting of a speaker) of end device 177 after the installation of Software #n, a duration for installing Software #n, or a number or type of exceptions detected while installing Software #n, or other information.

In one example, controller 180 may store the response data signal in a test repository or other internal or external memory. Controller 180 may present information associated with the response data signal at a user interface coupled to controller 180, e.g., a monitor, a speaker, etc. Controller 180 may transmit the response data signal to another device in data communication (wired or wirelessly) with controller 180. Controller 180 may determine whether end device 177 is functioning properly based on the response data signal. For example, the response data signal may indicate that Software #n was successfully installed, indicating that end device 177 is functioning properly. As another example, controller 180 may have a local or remote memory storing an expected value for the response data signal or one or more templates for the response data signal. Controller 180 may compare the response data signal with one or more expected values or templates. If there is match, then controller 180 may determine that end device 177 is functioning properly. Software #n may, e.g., modify the range of volume settings of a speaker of end device 177 from 17 to 24 levels. The response data signal may represent the number of levels of volume settings on end device 177. Controller 180 may have a memory storing an expected value of the response data signal associated with Software #n to be 24. If controller 180 receives a response data signal indicating there are 24 levels on the volume settings, then controller 180 may compare the response data signal with the expected value and may determine that end device 177 is functioning properly. Still controller 180 may perform other analysis or operations on the response data signal.

In one example, end devices 176-179 may be same devices, or different devices, models or versions. End devices 176-179 may have the same or different hardware or software. For example, end devices 176 and 177 may be headset version #1 and headset version #2, respectively, and end devices 178 and 179 may be speaker version #1 and speaker version #2, respectively. Controller 180 may cause the same or different operations to be executed on end devices 176-179, e.g., installing Software #n on end devices 176-179. Controller 180 may also receive response data signals from end devices 176-179. Controller 180 may use response data signals to determine that end devices 176-179 are functioning properly. For example, controller 180 may generate a first control signal to route data between connector 162 and connector 166 and may generate a second control signal to cause transmission of a first USB-formatted data signal from host device 172 to end device 176, using Path #w. Controller 180 may receive a first response data signal from end device 176. Controller 180 may then automatically generate a third control signal to route data between connector 162 and connector 167 and may generate a fourth control signal to cause transmission of a second USB-formatted data signal from host device 172 to end device 177, using Path #x. Controller 180 may receive a second response data signal from end device 177. Controller 180 may then automatically generate a fifth control signal to route data between connector 162 and connector 168 and may generate a sixth control signal to cause transmission of a third USB-formatted data signal from host device 172 to end device 178, using Path #y. In a similar fashion, multiple end devices coupled to the hardware interface selector may be automatically tested using the hardware interface selector.

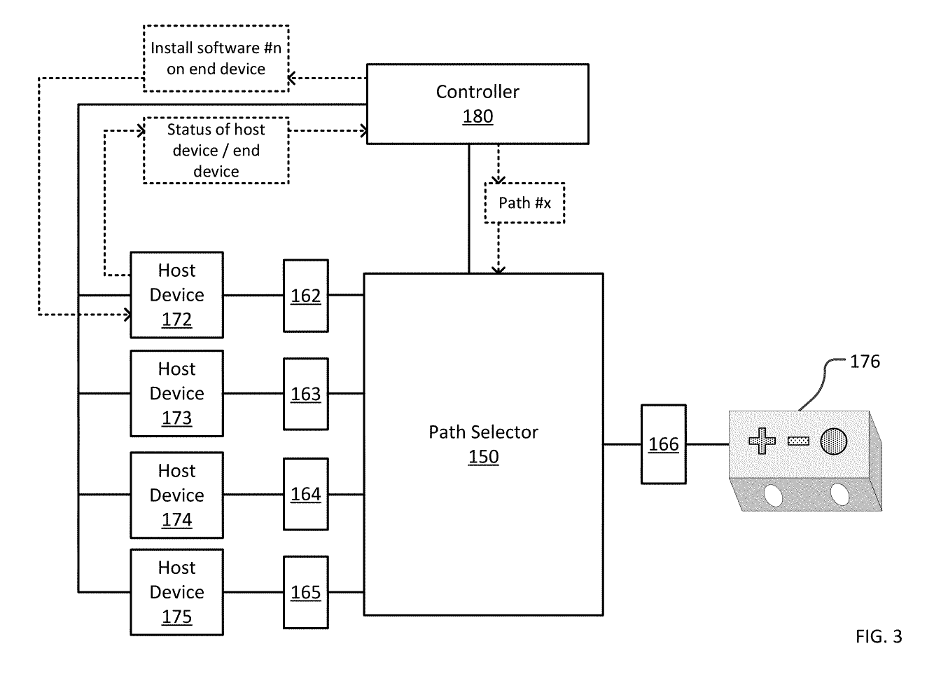

FIG. 3 illustrates an application of an exemplary hardware interface selector with host devices and an end device in some applications, according to some examples. Similarly-named and/or similarly-numbered elements shown in FIG. 1A may at least include similar or equivalent structures and/or functions. Here, a hardware interface selector (not shown) may include a path selector 150, connectors 162-169, and a controller 180. As shown, controller 180 may be coupled to path selector 150 and host devices 172-175. Path selector 150 may be coupled to connectors 162-169. Connectors 162-169 may be coupled to host devices 172-175 and an end device 176, and connectors 162-169 may be USB connectors. Path selector 150 may be configured to route data between connector 162-165 and connectors 166 using a number of paths, e.g., Path #w, Path #x, Path #y, Path #z, etc. Path #w may route data between connector 162 and connector 166. Path #x may route data between connector 163 and connector 166. Path #y may route data between connector 164 and connector 166. Path #z may route data between connector 165 and connector 166.

In one example, as shown, controller 180 may generate a first control signal to route data using “Path #x.” Controller 180 may further generate a second control signal to host device 173 to install software on end device 166. The new software may be selected from a plurality of applications or software versions, e.g., Software #m, Software #n, etc. As shown, the second control signal may cause host device 173 to install Software #n to end device 176. Host device 173 may transmit a data signal, e.g., a USB-formatted data signal, to be received by end device 176, instructing or causing end device 176 to install Software #n. Connector 163 may be coupled to host device 173 and may receive the USB-formatted data signal, and then path selector 150 may receive the USB-formatted data signal. Path selector 150 may route the USB-formatted data signal to connector 166 based on the first control signal, forming a connection between connector 163 and connector 166. Connector 166 may be coupled to end device 176 and may cause transmission of the USB-formatted data signal to end device 176. Thus, the hardware interface selector may select one or more of host devices 172-175 to interface with end device 176. Still other implementations may be possible.

In one example, host devices 172-175 may be same devices, or different devices, models or versions. Host devices 172-175 may have the same or different hardware or software. For example, host device 172 may be a machine developed by Apple Inc. of Cupertino, Calif. running a OS X operating system, host device 173 may be a machine developed by Apple Inc. of Cupertino, Calif. running a Microsoft Windows operating system, host device 174 may have a Linux operation system, host device 175 may be a machine developed by Dell Inc. of Round Rock, Tex. running a Microsoft Windows operating system. Similar to the hardware interface selector illustrated in FIG. 2, the hardware interface selector in FIG. 3 may continuously or automatically run tests through host devices 172-175. Controller 180 of the hardware interface selector may also automatically receive response data signals from host devices 172-175 and end device 176. Controller 180 may store response data signals in a local or remote memory and may transmit response data signals to another device in data communication (wired or wirelessly) with controller 180. Controller 180 may determine whether the end device is functioning properly when interacting with host devices 172-175 based on one or more response data signal from host devices 172-175 and end device 176. Controller 180 may perform other analyses or operations on the response data signals.

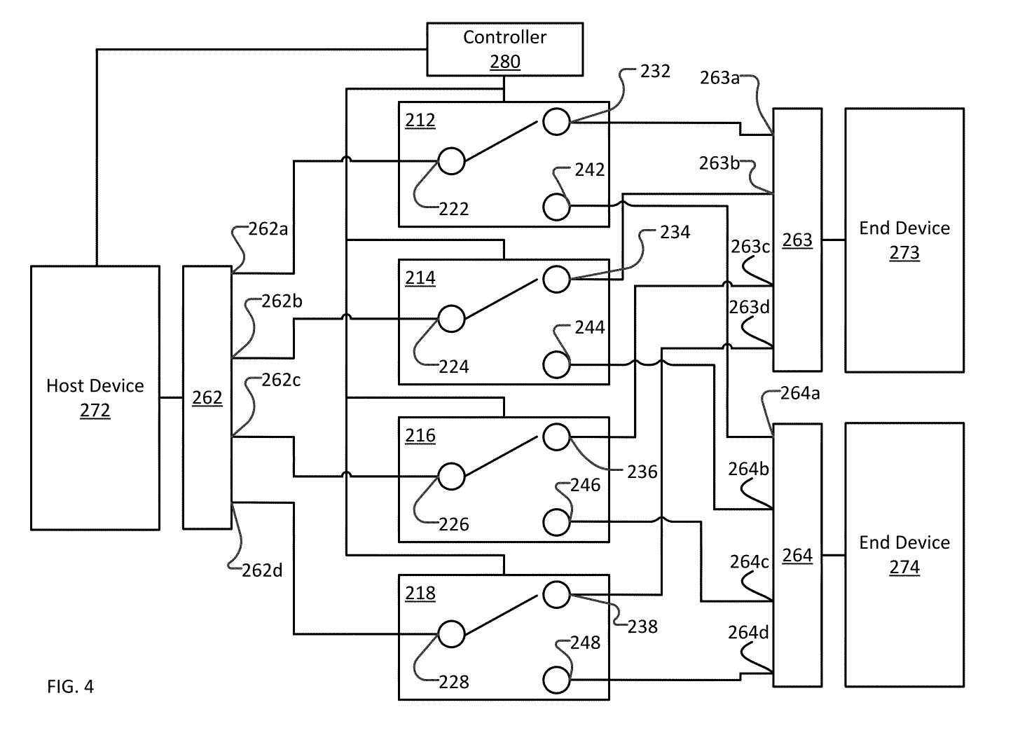

FIG. 4 illustrates a block diagram of an exemplary hardware interface selector with a host device and end devices, according to some examples. Here, a hardware interface selector (not shown) may include path selectors 212-218, connectors 262-264, and controller 280. Path selectors 212-218 may be switches or other devices for routing data between contacts. As shown, a switch may be a single-pole-dual-throw switch, each switch having one pole contact 222-228 and two throw contacts 232-238 and 242-248. In one example, a switch may be a Songle switch developed by Ningbo Songle Relay Co., Ltd., of China. The path selectors 212-218 or switches may be coupled to a relay board. In one example, a relay board may be a relay board developed by SainSmart. Each throw contact 232-238 and 242-248 may be configured to be coupled to a different end device. A path selector or switch may be configured to adopt different positions, each position connecting a pole contact with a different throw contact. For example, in a single-pole-dual-throw switch, when the pole contact is connected with the first throw contact, a closed path may be formed for a signal to be routed to the end device coupled to the first throw contact, and the path between the pole contact and the second throw contact may be open, severed, broken or disconnected. For example, as shown, throw contacts 232 and 242 are two positions that can be adopted by path selector 212 and may be configured to connect to the corresponding pole contact 222. Connectors 262-264 may be USB connectors and may have terminals, wires or pins 262a-d, 263a-d and 264a-d. Connectors 262-264 may be other types of connectors or have a different number of pins. Connectors 262-264 may be coupled to host device 272 and end devices 273-274. As shown, connectors 262-264 may have a plurality of terminals, wires or pins, e.g., four pins. Each pin of connector 262 may be connected to a pole contact 222-228. Each pin of connector 263 may be connected to a throw contact of the first subset of throw contacts 232-238. Each pin of connector 264 may be connected to a throw contact of the first subset of throw contacts 242-248.

Path selectors 212-218 or switches of path selectors 212-218 may be controlled by a control input. The control input may be a certain voltage, e.g., 5 V. For example, when no voltage is applied to the control input, path selectors 212-218 may be positioned to connect the pole contacts 222-228 to the first subset of throw contacts 232-238, and when a voltage signal, e.g., 5 V, is applied to the control input, path selectors 212-218 may be positioned to connect the pole contacts 222-228 to the second subset of throw contacts 242-248. Other configurations of pole contacts and throw contacts, and other types of switches may also be used.

Controller 280 may generate a first control signal to route data between pole contacts 222-228 and one of throw contacts 232-238 and 242-248. The first control signal may transmit a signal, e.g., a 5 V signal, to the control input of each of path selectors 212-218. For example, the first control signal may be a series of binary digits indicating whether to apply or not apply a voltage signal to each path selector. For example, the first binary digit may correspond to path selector 212, the second binary digit may correspond to path selector 214, the third binary digit may correspond to path selector 216 and the fourth binary digit may correspond to path selector 218. For example, a control signal of 0000 may route data between pole contacts 222-228 and the first subset of throw contacts 232-238, a control signal of 1111 may route data between pole contacts 222-228 and the second subset of throw contacts 242-248, a control signal of 0011 may route data between pole contacts 222-224 and throw contacts 232-234 and between pole contacts 226-228 and throw contacts 246-248, etc. For example, to route data from connector 262 to connector 263, controller 280 may generate a first control signal, e.g., 0000, that routes data between pole contacts 222-228 and the first subset of throw contacts 232-238.

Controller 280 may also generate a second control signal to cause transmission of a data signal, e.g., a USB-formatted data signal, from host device 272 to one of end devices 273 and 274. As described above, by synchronizing the first control signal and the second control signal, controller 280 may automatically run or install test applications or new software on end devices 273 and 274. Still other implementations may be possible. For example, one or more path selectors may be used, and each path selector may comprise one or more switches or other devices for routing data between contacts.

Controller 280 may receive a response data signal from host device 272 and end devices 273-274. For example, a response data signal may be received at connector 263 and received at the first subset of contacts 232-238. The response data signal may be routed to pole contacts 212-218 by path selectors 212-218 based on a first control signal or other control signal generated by controller 280. The response data signal may be received at connector 262 and then at host device 272. Controller 280 may receive the response data signal from host device 272. Still other implementations may be possible.

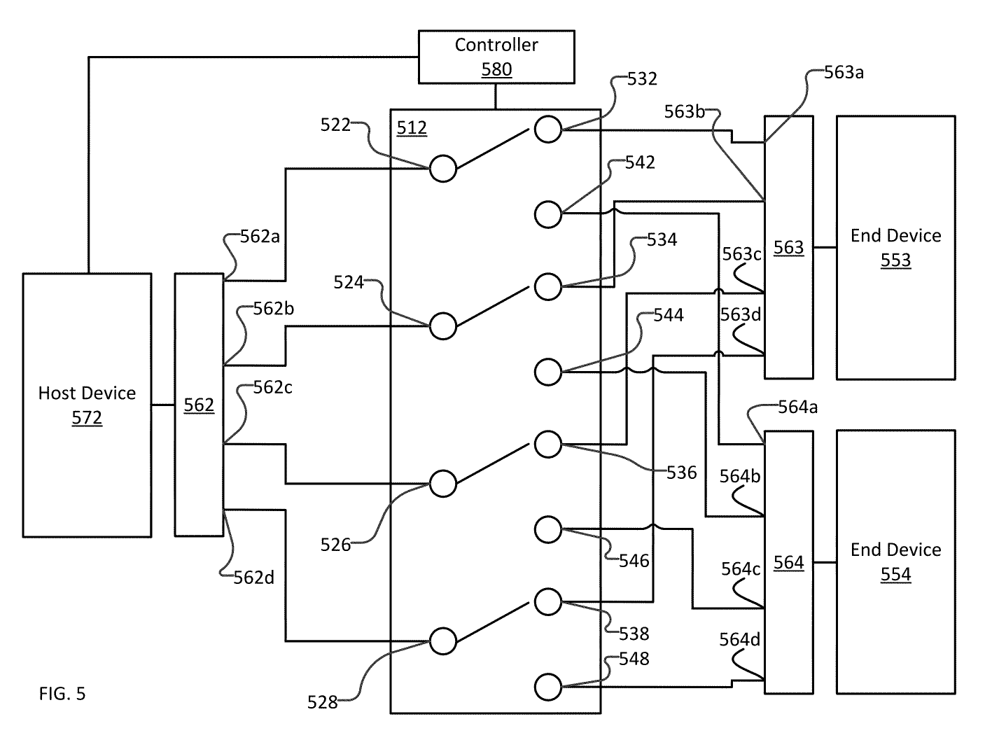

FIG. 5 illustrates another block diagram of an exemplary hardware interface selector with a host device and end devices, according to some examples. Here, a hardware interface selector (not shown) may include a path selector 512, connectors 562-564, and controller 580. As shown, path selector 512 may be one or more switches or other devices for routing data between contacts. Here, path selector 512 may be a four-pole-eight-throw switch, having four pole contacts 522-528 and eight throw contacts 532-538 and 542-548. Each pin of connector 562 may be coupled to a pole contact 522-528, and connector 562 may be configured to be coupled to a host device. Each pin of connector 563 may be coupled to a throw contact of a first subset of throw contacts 532-538, and connector 563 may be configured to be coupled to end device 553. Each pin of connector 564 may be coupled to a throw contact of a second subset of throw contacts 542-548, and connector 564 may be configured to be coupled to end device 554.

Similar to path selectors 212-218 illustrated in FIG. 4, path selector 512 may be controlled by one or more signals applied to one or more control inputs. As described above, controller 580 may generate a first control signal, e.g., 1111, to transmit 5 V signals to the control inputs of path selector 512, and path selector 512 may then route data between pole contacts 522-528 and the second subset of throw contacts 542-548. Controller 580 may also generate a second control signal to cause transmission of a data signal, e.g., a USB-formatted data signal, from host device 572 to one of end devices 553 and 554. Still other implementations may be possible. For example, one or more path selectors may be used, and each path selector may comprise one or more switches or other devices for routing data between contacts.

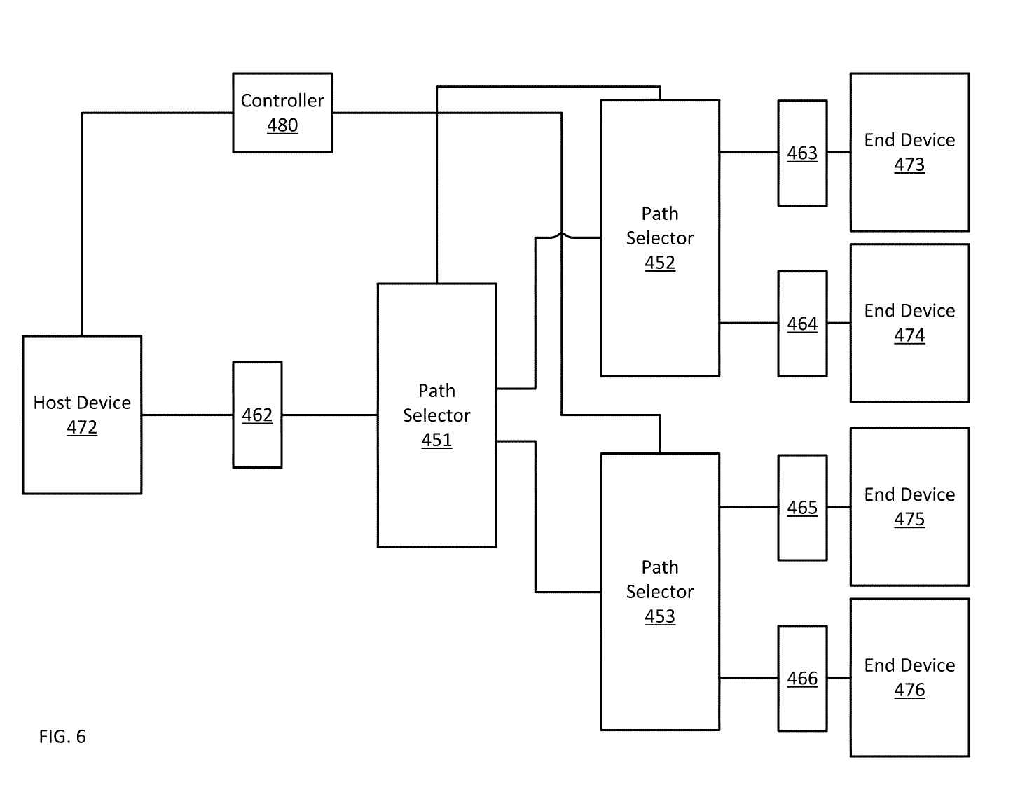

FIG. 6 illustrates another block diagram of an exemplary hardware interface selector with a host device and end devices, according to some examples. Here, a hardware interface selector (not shown) may include path selectors 451-453, connectors 462-466, and controller 480. Connectors 462-466 may be coupled to host device 472 and end devices 473-476. Path selectors 451-453 may route data between connector 462 and connectors 463-466. For example, path selector 451 may comprise four single-pole-dual-throw switches, with each of the four pole contacts connected to each of four pins of connector 472. Other numbers of pole contacts and pins may also be used. Path selectors 452 and 453 may be coupled to connectors 463-466 in a similar fashion.

In one example, as shown, path selectors 451-453 may be arranged in a cascade fashion. A first subset of path selectors, e.g., path selector 451, may be coupled to a second subset of path selectors, e.g., path selectors 452-453. In this arrangement, data may be routed from host device 472 to the first subset of path selectors, e.g., path selector 451, then to the second subset of path selectors, e.g., path selectors 452-453, then to end devices 473-476. Controller 480 may generate a first control signal to route data using the cascade arrangement of path selectors 451-453. For example, to route data from host device 472 to end device 473, the first control signal may use path selector 451 to route data along the “top path,” from connector 462 to path selector 452, and then use path selector 452 to route data along the “top path,” from path selector 451 to connector 463. The first control signal may be a set of binary digits or other commands or signals. For example, the first four binary digits may correspond to the first subset of path selectors, e.g., path selector 451, and the next four binary digits may correspond to the second subset of path selectors, e.g., path selectors 452-453. For example, a binary digit of 0 may indicate routing data along a “top path” of a path selector or switch, and a binary digit of 1 may indicate routing data along a “bottom path” of a path selector. For example, to route data from host device 472 to end device 473 using the above example, the first control signal may be 00000000, so that path selector 451 selects the “top path” to route to path selector 452, and path selector 452 selects the “top path” to route to connector 463. To route data from host device 472 to end device 474, the first control signal may be 00001111, so that path selector 451 selects the “top path” to route to path selector 452, and path selector 452 selects the “bottom path” to route to connector 464. Data may be routed to end devices 475 and 476 using a first control signal in a similar fashion. In another example, the first control signal may be a set of binary digits, wherein one binary digit corresponds to multiple path selectors or switches, e.g., four switches. The first binary digit may correspond to the first subset of path selectors, e.g., path selector 451, and the second binary digit may correspond to the second subset of path selectors, e.g., path selectors 452-453. For example, first control signal may be 10. Path selector 451 may select the “bottom path” based on the first digit, “1,” and path selector 453 may select the “top bath” based on the second digit, “0.” Still other control signals and implementations may be possible.

As described above, controller 480 may also generate a second control signal to cause transmission of a data signal, e.g., a USB-formatted data signal, from host device 472 to one of end devices 473-476. Thus path selectors 415-453 may route a USB-formatted data signal from host device 472 to one of end devices 473-476. Unlimited levels of the cascade may be used, and each path selector may have an unlimited number of switches or contacts.

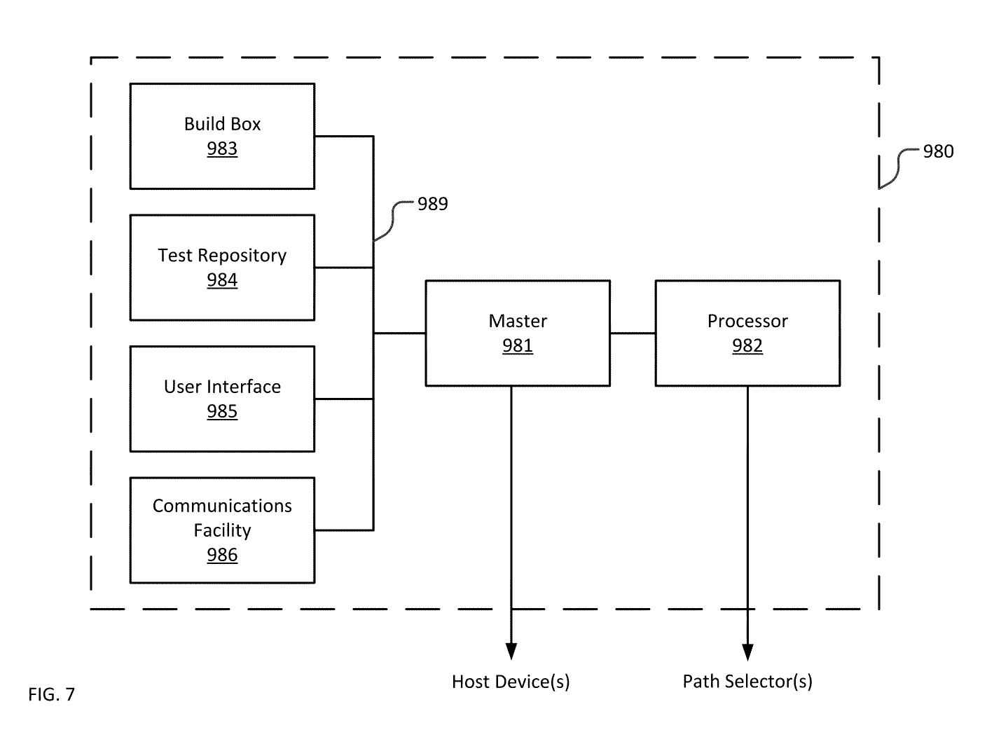

FIG. 7 illustrates a block diagram of an exemplary controller configured to be used in an exemplary hardware interface selector, according to some examples. Here, controller 980 comprises a master device 981, a processor 982, a build box 983, a test repository 984, a user interface 985, a communications facility 986, and a bus 989. One or more elements 981-986 may be implemented in hardware or software, and in different devices or in the same device. One or more elements 981-986 may also be installed, fabricated, manufactured, or integrated with controller 980 (as shown) or may be remote from controller 980. In some examples, the quantity, type, function, structure and configuration of controller 980 and elements 981-986 shown may be varied and are not limited to the examples provided.

Processor 982 may be a processor, a microprocessor, a microcontroller, a single-board microcontroller or other device configured to generate a first control signal to use one or more path selectors to route data between contacts of the path selectors. For example, processor 982 may be an Arduino single-board microcontroller, or processor 982 may comprise an ATMEL microcontroller developed by Atmel Corporation of San Jose, Calif. The first control signal may generate a voltage signal, e.g., a 5 V signal, to be applied to a control input of a path selector, switch or other device configured to route data. For example, the first control signal may be a series of digits, each digit indicating a voltage to be applied to a control input. For example, the first digit may correspond to a first path selector or switch, the second digit may correspond to a second path selector, and so on. A “0” may indicate applying a 0 V signal to a path selector to select a first path or a top path of the path selector, and a “1” may indicate applying a 5 V signal to select a second path or a bottom path of the path selector. For example, the first control signal may be a series of digits, wherein a “0” indicates applying a first voltage to select a first path of a path selector, a “1” indicates applying a second voltage to select a second path, and a “2” indicates applying a third voltage to select a third path.

Master 981 may be a computing device or other processor configured to generate a second control signal to cause transmission of a data signal from one or more host devices to one or more end devices. Master 981 may have a separate processor or microprocessor apart from processor 982. Master 981 may be implemented as logic to provide control functions and signals to elements 981-986. Master 981 may synchronize the generation of the first control signal and the generation of the second control signal such that the end device to which the data signal is being transmitted based on the second control is also the end device to which data is being routed based on the first control signal. Master 981 may deploy, operate or use a test automation framework or application, such as eggPlant developed by TestPlant of London, the United Kingdom, Selenium, and others. For example, the data signal may be configured to use a host device to install software, firmware, application, program or set of executable instructions on an end device. As another example, the data signal may be configured to use a host device to perform or execute an operation on an end device, e.g., adjust a volume, adjust a lighting, turn on or off noise cancellation, turn on or off an audio filter, turn on or off an end device, etc. Still the data signal may be configured to perform other operations on the host device and the end device.

Build box 983 may be a set of applications, software versions, scripts, builds, or other executable instructions. Build box 983 may deploy, operate or use an integration tool such as Jenkins to continuously or automatically run repeated software jobs, operations, or applications or to integrate changes to applications. A script may be a batch script, an AppleScript developed by Apple Inc. of Cupertino, Calif., a graphical interface configured to select icons displayed on a screen, etc. A script may include a set of instructions for testing or using a host device and an end device. For example, a script may command a host device to identify an end device, then command the host device to prepare Software #n to be installed on the end device, then command host device to transmit a data signal to the end device to install Software #n. A script may also include commands associated with a response data signal or other feedback. For example, a script may command a host device to prompt the end device to transmit a response data signal. The response data signal may indicate a status of the end device, e.g., which software is currently installed on the end device. The script may then command the host device to transmit the response data signal to controller 980. A script may also adjust a setting of an end device, e.g., changing the volume, changing the lighting, turning on or off a setting or application, or other operations. For example, master 981 may retrieve a build from build box 983, and generate and transmit a second control signal to a host device, in order to implement the build on the host device and the end device. As another example, master 981 may run a build on one host device or end device and then automatically run the build (or a different build) on the next host device or end device. As another example, master 981 may be used to create a new build to be stored in build box 983. For example, a user may type a new script using user interface 985, and store it as a new build in build box 983. A build may have an identifier in the form of a number, characters, or others used to distinguish one build from another.

Test repository 984 may be configured to store a response data signal from an end device. Test repository 984 may also be configured to store expected values or templates of response data signals, corresponding to the execution of a certain build from build box 983. Test repository 984 may be implemented with a memory, local or remote. Types of memory include random access memory (RAM), read only memory (ROM), dynamic RAM (DRAM), dynamic ROM (DROM), static RAM (SRAM), static ROM (SROM), cache memory, volatile memory, non-volatile memory, solid state memory, Flash memory, or other storage devices.

For example, master 981 may generate a second control signal configured to implement or install a certain build, e.g., Software# n, on an end device using a host device. Master 981 may receive a response data signal from the host device or the end device and store the response data signal in test repository 984. For example, the response data signal may indicate an identifier of the software currently installed on the end device, e.g., Software #n. Master 981 may also retrieve one or more expected values or templates of the response data signal associated with the build, and compare the expected values with the response data signal. Master 981 may determine whether the build was successfully completed or the end device is functioning properly based on the comparison. For example, the expected value may be Software #n. Master 981 may compare the response data signal with the expected value, determine a match, and determine that the end device is functioning properly. If master 981 determines that the end device is not functioning properly, master 981 may rerun the same build or run a different build, and receive another response data signal. Master 981 may also generate an error report. Still other analyses or operations may be performed on the response data signal.

User interface 985 may be configured to input or output data to and from an end user. User interface 985 may be implemented as a touchscreen, keyboard, mouse, joystick, LED light, display screen, speaker, microphone, or other device used to serve as an interface between controller 980 and the user. For example, a user may use a keyboard and mouse to select a build from build box 983 to be implemented. As another example, a user may use a keyboard and mouse to perform an analysis on response data signals stored in test repository 984. As another example, a user with a physical disability may use a speaker to provide a voice command, causing master 981 to generate a second control signal to adjust a setting of an end device. Still other usages of the user interface may be possible.

Communications facility 986 may be configured to transmit, receive, or exchange data with controller 980. Data received or saved at a remote or external device may be communicated through a network with communications facility 986. For example, communications facility 986 may include a wireless radio, control circuit or logic, antenna, transceiver, receiver, transmitter, resistors, diodes, transistors or other elements that are used to transmit or receive data to and from controller 980. In some examples, communications facility 986 may be implemented to provide a wired data communication capability such as an analog or digital attachment, plug, jack, land line or the like to allow for data to be transferred. In other examples, communications facility 986 may be implemented to provide wireless data communication capability to transmit digitally encoded data across one or more frequencies using various types of data communication protocols, without limitation. For example, a user at a remote location may use a touchscreen of a smartphone to select a command or build to be implemented on a host device or an end device. Communications facility 986 receives data representing this selection, and causes controller 980 to execute the command or build. Communications facility 981 may also be used to transmit and receive data between master 981 and a remote test repository or other memory.

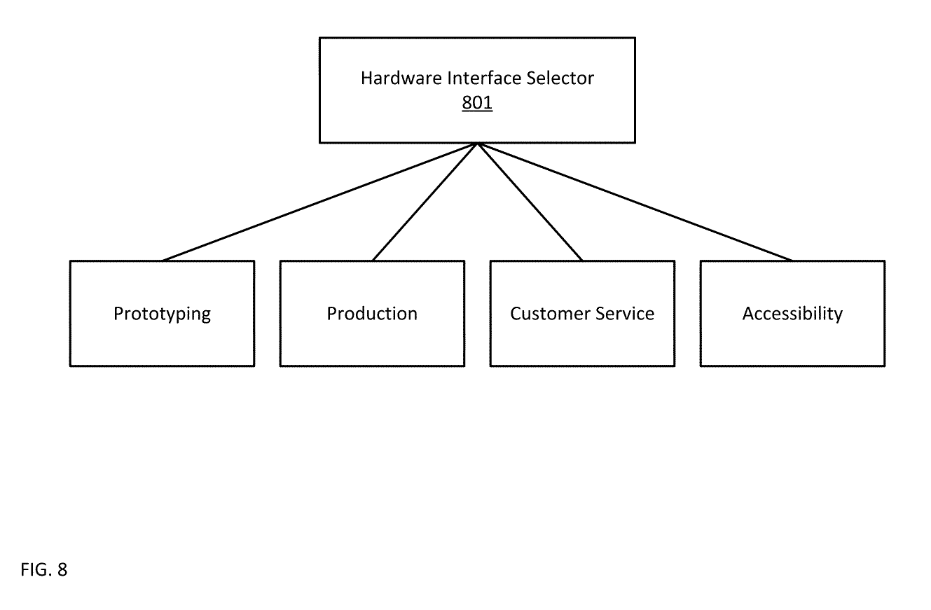

FIG. 8 illustrates applications of an exemplary hardware interface selector, according to some examples. A hardware interface selector 801 may be used in a variety of settings for a variety of purposes. For example, hardware interface selector 801 may be used for prototyping. Hardware interface selector 801 may run and test a build, software, firmware, program, application, or set of executable instructions on one or more host devices and one or more end devices, while eliminating or reducing the amount of manual intervention required for establishing or modifying a hardware interface connection of the host devices and the end devices. For example, host devices and end devices may be coupled to multiple connectors of hardware interface selector 801. A build may be saved on a build box or another module or component in data communication with a controller of hardware interface selector 801. A master or another processor or module of hardware interface selector 801 may generate a first control signal to route data between the host devices and the end devices, and may generate a second control signal to cause transmission of data from the host devices to the end devices. The master may receive response data signals from the host devices and end devices and may determine whether the prototype is functioning properly, e.g., the build is successfully installed, whether the response data signals match expected values, etc. Various host devices and end devices may be tested simultaneously, consecutively or continuously. For example, some devices may be connected, causing the host device to detect an attachment of an end device, while others may be severed, causing the host device to detect a detachment of an end device. The prototype may be modified or improved based on the response data signals.

As another example, hardware interface selector 801 may be used for production, e.g., testing products, generating statistics on quality assurance and quality control, etc. For example, end devices generated from the same production line or different production lines may be coupled to hardware interface selector 801, and a host device may also be coupled to hardware interface selector 801. A controller of hardware interface selector 801 may initiate a test program. The controller may generate a first control signal to route data from the host device to the end devices, and may generate a second control signal to cause transmission of data from the host device to the end devices. Using the first control signal and the second control signal, hardware interface selector 801 may run the test program on all or a subset of end devices, and the test program may be run on the end devices successively or simultaneously. Further, one or more test programs may be run. Response data signals may be stored on a test repository or other memory in data communication with hardware interface selector 801. Hardware interface selector 801 may generate various relationships, statistics or information based on the response data signals. For example, hardware interface selector 801 may record the number of response data signals that are of a certain value and the number of response data signals that are of another value, calculate or analyze a distribution of the values of the response data signals, analyze whether certain values of response data signals correspond to a certain time period, manufacturer, employee, material, or hardware, etc. The information may be used to change, refine or improve the production process.

As another example, hardware interface selector 801 may be used for customer service, e.g., detecting exceptions or errors in an end device, etc. Hardware interface selector 801 may be coupled to an end devices reported by a customer as not functioning properly and various host devices. Various tests may be run across the host devices interacting with the end device. Based on response data signals, hardware interface selector 801 may detect whether a certain host device caused the error on the end device, or what process, instruction, application, command, operating system, firmware, etc., generated the error or exception.

As another example, hardware interface selector 801 may be used for accessibility, e.g., controlling and interacting with hardware interfaces of end devices by using an alternate command signal, e.g., software, voice control, remote control, and the like. For example, an end user may be physically disabled and unable to physically connect the hardware interfaces of host devices and end devices. Hardware interface selector 801 may be coupled to various host devices and end devices. Various alternate command signals may be available on a memory in data communication with hardware interface selector 801. For example, a voice command, “Raise the volume on the speaker,” may generate a control signal to raise the volume on the speaker, or a voice command, “Use noise cancellation on the microphone,” may activate the noise cancellation feature on the microphone. As another example, an assistant of the end user may input a command on a user interface or device (local or remote) that is in data communication with hardware interface selector 801. The device may be a keyboard, a smartphone or other computer or computing device. The assistant's command may be to increase the volume of a speaker. Hardware interface selector 801 may generate a first control signal to route data between selected host devices and selected end devices, and generate a second control signal to cause transmission of data from the host devices to the end devices, wherein the data causes execution of the desired operation. Hardware interface selector 801 may receive response data signals that may be used to acknowledge or confirm completion of the operation. Still, other implementations and usages of hardware interface selector 801 may be used.

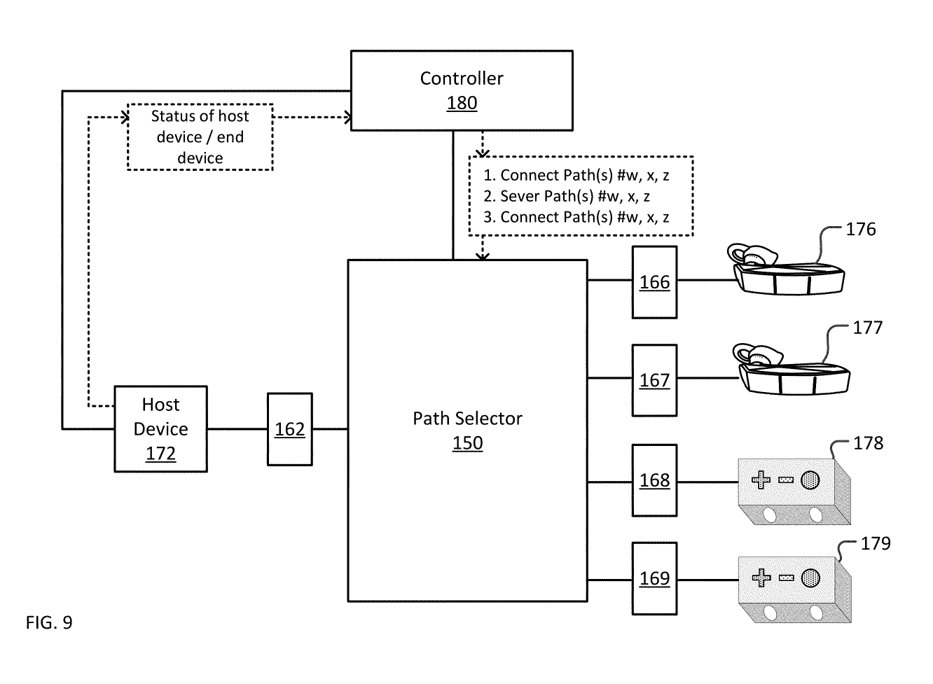

FIG. 9 illustrates an application of an exemplary hardware interface selector with a host device and end devices in some applications, according to some examples. Similarly-named and/or similarly-numbered elements shown in FIG. 1A may at least include similar or equivalent structures and/or functions. Here, a hardware interface selector (not shown) may comprise a path selector 150, connectors 162-169, and a controller 180. As shown, controller 180 may be coupled to path selector 150 and a host device 172. Path selector 150 may be coupled to connectors 162-169. Connectors 162-169 may be coupled to host device 172 and end devices 176-179, and connectors 162-169 may be USB connectors. Path selector 150 may be configured to route data between connector 162 and connectors 166-169 using a number of paths, e.g., Path #w, Path #x, Path #y, Path #z, etc. Path #w may route data between connector 162 and connector 166. Path #x may route data between connector 162 and connector 167. Path #y may route data between connector 162 and connector 168. Path #z may route data between connector 162 and connector 169. Multiple paths may be connected or used simultaneously or consecutively.

In one example, controller 180 may generate a first control signal to route data, e.g., using “Paths #w, x, z.” Multiple paths may be selected simultaneously or consecutively. Controller 180 may further generate a second control signal to host device 172 to perform an operation on end devices 176, 177 and 179. The operation on end devices 176, 177 and 179 may be the same or different. Host device 172 may transmit a data signal, e.g., a USB-formatted data signal, to be received by end devices 176, 177 and 179, instructing or causing end device 176, 177 and 179 to perform the operation. Connector 162 may be coupled to host device 172 and may receive the USB-formatted data signal, and then path selector 150 may receive the USB-formatted data signal. Path selector 150 may route the USB-formatted data signal to connectors 166, 167 and 169 using Paths #w, x, z, based on the first control signal, forming a connection between connector 162 and connectors 166, 167 and 169. Connectors 166, 167 and 169 may be coupled to end devices 176, 177 and 179, and may cause transmission of the USB-formatted data signal to end devices 176, 177 and 179. Thus the hardware interface selector selects one or more of end devices 176-179 to interface with host device 172. Still other implementations may be possible.

In another example, controller 180 may generate a first control signal to route data, e.g., using “Paths #w, x, z.” Path selector 150 may connect connector 162 and connectors 166, 167 and 169 based on the first control signal. Based on the connections, host device 172 detects the attachment of end devices 176, 177 and 179. Host device 172 and end devices 176, 177 and 179 may be in data communication using various protocols or standards, e.g., USB. Based on specifications of the protocol or standard, host device 172 may identify and configure end devices 176, 177 and 179. For example, host device 172 may enumerate end devices 176, 177 and 179 and assign a USB address to end devices 176, 177 and 179. Based on the specifications of the USB 3.0 standard, for example, the address is a value between 1 and 127.

In another example, after controller 180 generates a first control signal to route data using “Paths #w, x, z,” controller 180 may generate a second control signal severing or breaking these paths or connections (or a subset of them), and generate a third control signal to route data using “Paths #w, x, z” again. Path selector 150 may disconnect connector 162 and connectors 166, 167 and 169, and then reconnect connector 162 and connectors 166, 167 and 169. Based on the disconnection, host device 172 may detect a detachment of end devices 176, 177 and 179. End devices 176, 177 and 179 may be reset when detached. Based on the re-connection, host device 172 may detect the attachment of end devices 176, 177 and 179 again. Host device 172 may identify, configure, or renumerate end devices 176, 177 and 179. For example, host device 172 may assign a different USB address to end devices 176, 177 and 179. In one example, a large number of paths, e.g., twenty or more, of the path selector may be connected, thereby attaching a large number of end devices to host device 172. Host device 172 may need to identify and configure a large number of end devices at once, and controller 180 may determine whether the configuration of the end devices by host device 172 is complete or successful.

In one example, controller 180 may receive a response data signal or other data representing a status of host device 172 or end devices 176-179. In one example, host device 172 or end device 177 may initiate transmission of the response data signal following performance of an operation of end devices 176, 177 and 179, or following identification, configuration or enumeration of end devices 176, 177 and 179. A response data signal from end device 177 may be received at connector 167 and routed to connector 162 using Path #x based on the first control signal. Host device 172 may receive the response data signal and transmit the response data signal to controller 180. In one example, controller 180 may send a control signal (not shown) prompting or querying host device 172 for the response data signal. The response data signal may include data representing the operation was completed, the identification, configuration or enumeration was completed, the USB addresses of end devices 176, 177 and 179, a setting of end device 176, 177 and 179, a duration for identifying, configuring or enumerating end devices 176, 177 and 179, a number or type of exceptions or errors detected while performing the operation or configuring end devices 176, 177 and 179, or other information.

In one example, controller 180 may store the response data signal in a test repository or other internal or external memory. Controller 180 may transmit the response data signal to another device in data communication (wired or wirelessly) with controller 180. Controller 180 may determine whether end devices 176, 177 and 179 are functioning properly based on the response data signal. For example, the response data signal may indicate that USB addresses were assigned to end devices 176, 177 and 179. As another example, controller 180 may have a local or remote memory storing an expected value for the response data signal or one or more templates for the response data signal. Controller 180 may compare the response data signal with one or more expected values or templates. If there is match, then controller 180 may determine that end devices 176, 177 and 179 are functioning properly. For example, the specific power requirement of end device 177 may be stored in memory. The response data signal may indicate a power requirement detected by host device 172 during configuration of end device 177. If the power requirement stored in memory matches the power requirement detected by host device 172, then controller 180 may determine that end device 177 is functioning properly. As another example, a test repository may store the USB addresses assigned to end devices 176, 177 and 179 during a first connection with host device 172, and store the USB addresses assigned to 176, 177 and 179 during a second connection with host device. Controller 180 may compare the USB addresses during the first connection and the USB addresses during the second connection to determine whether end devices 176, 177 and 179 were renumerated, indicating end devices 176, 177 and 179 are functioning properly. In another example, a large number of paths may be selected simultaneously, thereby connecting a large number of end devices to host device 172. The response data signal may be used to test a maximum load that may be carried by host device 172, by increasing the number of end devices attached to host device 172 until the end devices and host device 172 are not functioning properly, based on response data signals. For example, controller 180 may determine that host device 172 is functioning properly when nineteen end devices are attached based on a response data signal, then generate a first control signal to select an additional path of path selector 150 and a second control signal to rerun the test and receive another response data signal, then determine whether host device 172 is functioning properly when twenty end devices are attached. Still controller 180 may perform other analysis or operations on the response data signal.

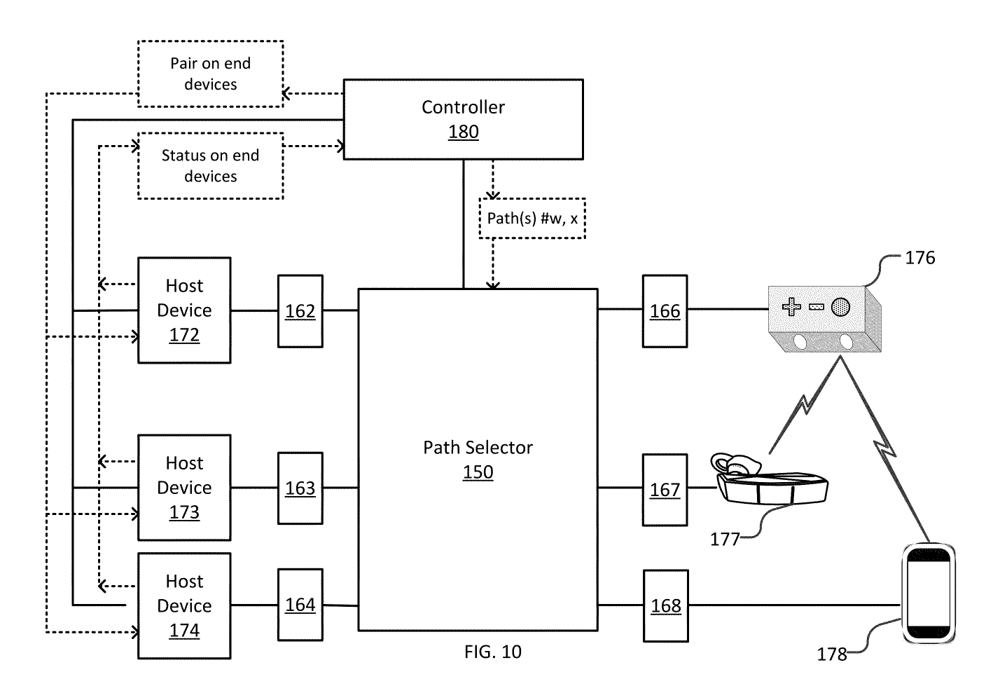

FIG. 10 illustrates an application of an exemplary hardware interface selector with host devices and end devices in some applications, according to some examples. Similarly-named and/or similarly-numbered elements shown in FIG. 1A may at least include similar or equivalent structures and/or functions. Here, a hardware interface selector (not shown) may comprise a path selector 150, connectors 162-169, and a controller 180. As shown, controller 180 may be coupled to path selector 150 and host devices 172-174. Path selector 150 may be coupled to connectors 162-169. Connectors 162-169 may be coupled to host devices 172-174 and end devices 176-178, and connectors 162-169 may be USB connectors. Path selector 150 may be configured to route data between connectors 162-164 and connectors 166-168 using a number of paths, e.g., Path #w, Path #x, Path #y, Path #z, etc. Path #w may route data between connector 162 and connector 166. Path #x may route data between connector 163 and connector 167. Path #y may route data between connector 164 and connector 168. Multiple paths may be connected or used simultaneously or consecutively.

In one example, as shown, controller 180 may generate a first control signal to route data, e.g., using “Paths #w, x.” Controller 180 may further generate a second control signal to host device 172 to cause end device 176 to perform an operation. The operation may be to wirelessly connect end device 176 and/or end device 177. For example, the wireless connection may be use a Bluetooth protocol, and the operation may be to pair end device 176 with end device 177 using a Bluetooth protocol. Host device 172 may transmit a data signal, e.g., a USB-formatted data signal, to be received by end device 176, instructing or causing end device 176 to initiate a data connection or communication link (wired or wireless) with end device 177. Connector 162 may be coupled to host device 172 and may receive the USB-formatted data signal, and then path selector 150 may receive the USB-formatted data signal. Path selector 150 may route the USB-formatted data signal to connector 166 based on the first control signal, forming a connection between connector 162 and connector 166. Connector 166 may be coupled to end device 176, and may cause transmission of the USB-formatted data signal to end device 176. End device 176 may initiate establishment of a wireless data connection with end device 177. In one example, the USB-formatted data signal may further cause execution of an operation of end device 177 after wireless data connection has been established.

In one example, controller 180 may receive a response data signal or other data representing a status from host devices 172-174 or end devices 176-178. Controller 180 may store the response data signal in a test repository or other memory. Controller 180 may perform analyses on the response data signal. Controller 180 may determine whether host devices 172-174 and end devices 176-178 are functioning properly based on the response data signal. For example, the response data signal may indicate that a wireless data connection was established between end device 176 and 177. In another example, host devices 172-173 may be the same device. Still, other implementations of the hardware interface selector are possible.

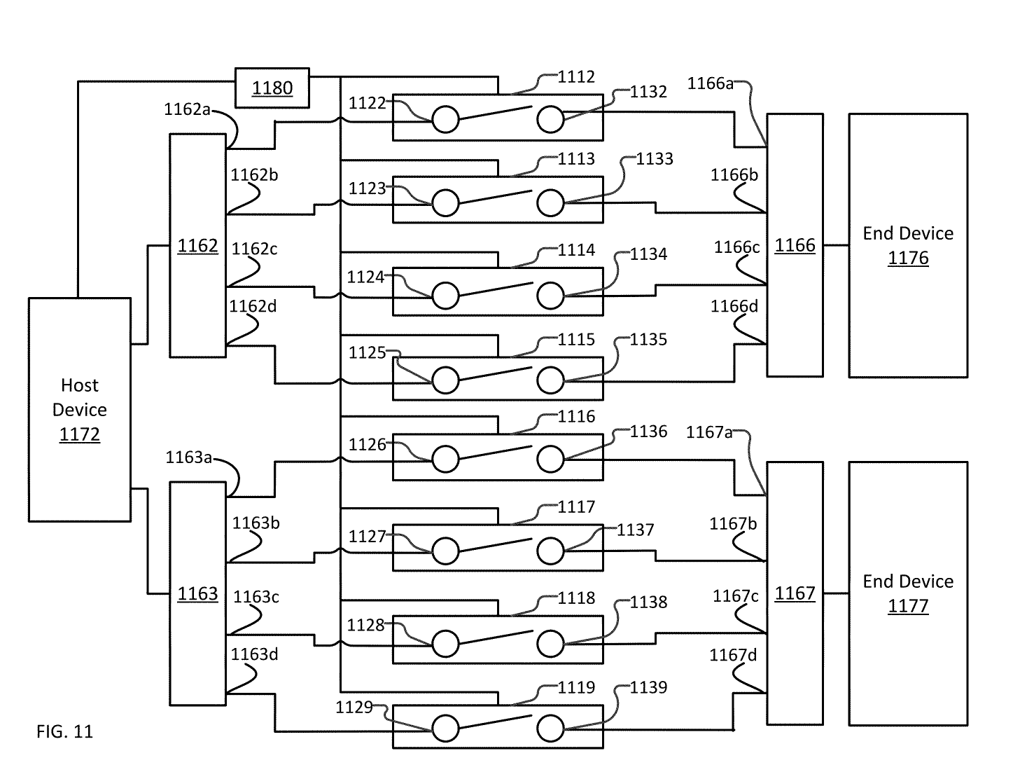

FIG. 11 illustrates a block diagram of an exemplary hardware interface selector with a host device and end devices, according to some examples. Here, a hardware interface selector (not shown) may comprise path selectors 1112-1119, connectors 1162-1167, and controller 1180. Path selectors 1112-1119 may be switches or other devices for routing data between contacts. As shown, a switch may be a single-pole-single-throw switch, each switch having one pole contact 1122-1128 and one throw contact 1132-1138. In one example, a switch may be a Songle switch developed by Ningbo Songle Relay Co., Ltd., of China. The path selectors 1112-1119 or switches may be coupled to a relay board. In one example, a relay board may be a relay board developed by SainSmart. The path selectors 1112-1119 may be switched to an open position or a closed position. The closed position may form a path between a pole contact 1122-1129 and its corresponding throw contact 1132-1139. The open position may disconnect the pole contact 1122-1129 from its corresponding throw contact 1132-1139. For example, closing the path selector 1112 forms a connection between pole contact 1122 and throw contact 1132. Similar to connectors 262-264 of FIG. 4, connectors 1162-1167 may be USB connectors and may have terminals, wires or pins 1162a-d, 1163a-d, 1166a-d, and 1167a-d. Connectors 1162-1167 may be coupled to host device 1172 and end devices 1176-1177. As shown, connectors 1162-1167 may have a plurality of terminals, wires or pins, e.g., four pins. Similar to connectors 262-264 of FIG. 4, for example, pins 1162a-d may be connected to pole contacts 1122-1125.

Similar to path selectors 212-218 of FIG. 4, path selectors 1122-1129 may be controlled by a control input. The control input may be a certain voltage, e.g., 5 V. For example, when no voltage is applied to the control input, path selectors 1122-1129 may be set to disconnect pole contacts 1122-1129 from throw contacts 1132-1139, and when a voltage signal, e.g., 5 V, is applied to the control input, path selectors 1122-1129 may be set to connect and form a closed path between pole contacts 1122-1129 and throw contacts 1132-1139. Other configurations of pole contacts and throw contacts, and other types of switches may also be used.

Similar to controller 280 of FIG. 4, controller 1180 may generate a first control signal to route data between pole contacts 1122-1129 and throw contacts 1132-1139. The first control signal may transmit a signal, e.g., a 5 V signal, to the control input of path selectors 1112-1119. For example, the first control signal may be a series of binary digits indicating whether to apply or not apply a voltage signal to each path selector.

Similar to controller 280 of FIG. 4, controller 1180 may also generate a second control signal to cause transmission of a data signal, e.g., a USB-formatted data signal, from host device 1172 to one or more of end devices 1176-1177. As described above, by synchronizing the first control signal and the second control signal, controller 1180 may automatically run or install test applications or new software on end devices 1176 and 1177. Controller 1180 may further receive a response data signal. Still other implementations may be possible. For example, connectors 1162-1163 may be coupled to two different host devices.

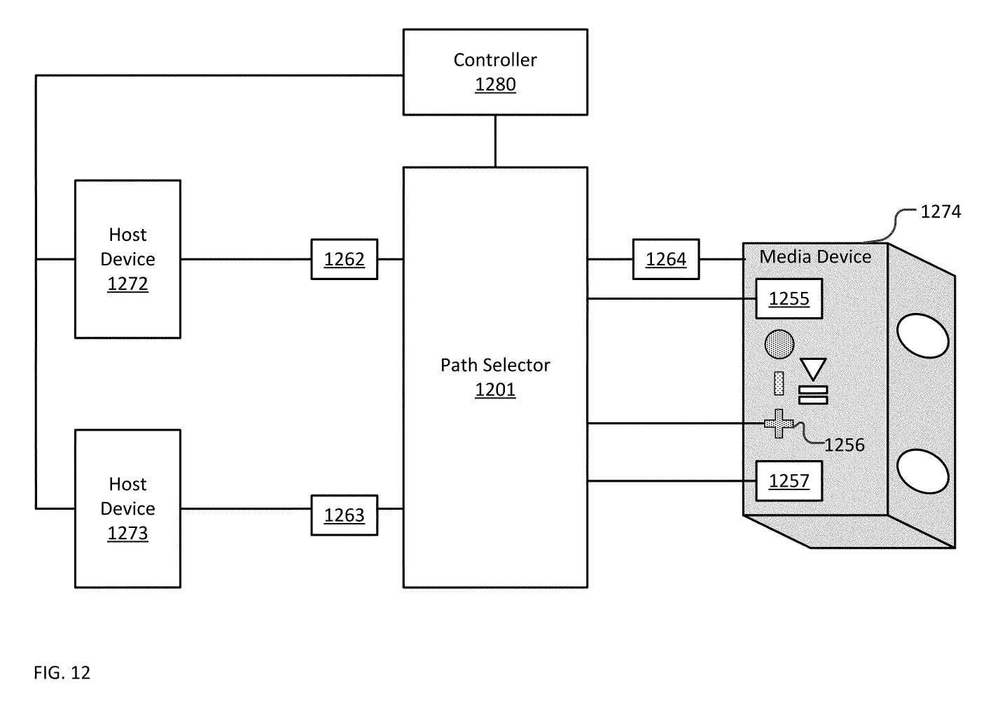

FIG. 12 illustrates an application of an exemplary hardware interface selector with host devices and an end device in some applications, according to some examples. Here, a hardware interface selector (not shown) comprises path selector 1201, connectors 1262-1264, and controller 1280. Connectors 1262-1264 may be coupled to host devices 1272-1273 and end device 1274. Connectors 1262-1264 may be USB connectors or other connectors or hardware interfaces. Path selector 1201 may further be coupled to a battery 1255, a mechanical switch or button 1256, and a memory 1257 of end device 1274. In one example, path selector 150 may be configured to route data between connectors 1262-1263 and connector 1264 based on a first control signal generated by controller 180. Connector 1262-1263 may be configured to exchange a data signal, e.g., a USB-formatted data signal, with host devices 1272-1273. The data signal may be formatted based on USB protocols, serial port protocols, parallel port protocols, audio port protocols, or other protocols. The data signal may be a control signal from host device 1272 or host device 1273 to install software, firmware, application, program, or set of executable instructions on end device 1274. Connector 1264 may be configured to exchange the data signal, e.g., the USB-formatted data signal, with end device 1274. Controller 180 may be configured to generate the first control signal to route data between host devices 1272-1273 and end device 1274, and to generate a second control signal to cause transmission of the data signal, e.g., the USB-formatted data signal, from host devices 1272-1273 to end device 1274.

In one example, path selector 1201 may be configured to be coupled to mechanical switch 1256, wherein mechanical switch 12256 may be configured to generate a signal representing a user input. Mechanical switch 1256 may be a button, a flip switch, a press-down switch, a slider, a toggle switch, a momentary switch, or another type switch. Mechanical switch 1256 may have two or more positions. For example, a press-down switch may be configured to be in an open position when not pressed (e.g., a circuit coupled to mechanical switch 1256 is open or disconnected) and be in a closed position when pressed (e.g., the circuit coupled to mechanical switch 1256 is closed or connected). The closed position (e.g., closing of the circuit) may generate a control signal or instruction to end device 1274. For example, pressing mechanical switch 1256 may toggle between turning on and turning off end device 1274. As another example, end device 1274 may be a speaker, and pressing mechanical switch 1256 may increase the volume by one level.

Path selector 1201 may be configured to form a closed path, in place of closing mechanical switch 1256, based on a third control signal generated by controller 1280. The closed path of path selector 1201 may generate an electrical signal representing a closing of mechanical switch 1256 to end device 1274. For example, one end of mechanical switch 1256 is coupled to one end of a circuit of end device 1274, and another end of mechanical switch 1256 is coupled to another end of the circuit of end device 1274. A closing of mechanical switch 1256 may close the circuit, thereby causing execution of an operation performed by the circuit. Path selector 1201 may comprise a switch, e.g., a single-pole-single-throw switch, wherein one contact of the single-pole-single-throw switch may be coupled to one end of mechanical switch 1256 (which is coupled to one end of the circuit of end device 1274), and another contact of the single-pole-single-throw switch may be coupled to another end of mechanical switch 1256 (which is coupled to another end of the circuit of end device 1274). If path selector 1201 closes the single-pole-single-throw switch, the circuit of end device 1274 may be closed, as if mechanical switch 1256 were closed. The closing of the single-pole-single-throw switch may generate an electrical signal representing a closing of mechanical switch 1256. Still, other implementations may be possible. For example, a single-pole-dual-throw switch may be used, wherein one throw contact may be coupled to mechanical switch 1256, and the other throw contact may remain open or disconnected.

In one example, path selector 1201 may be configured to be coupled to battery 1255, memory 1257, or other component of end device 1274. Controller 1280 or a different device may be configured to detect an analog signal representing a status of end device 1274, e.g., a level of battery 1255, or to retrieve a flag or other data representing a status of end device 1274 from memory 1257. For example, path selector 1201 may comprise a switch, e.g., a single-pole-single-throw switch. The switch may be coupled to battery 1255 and controller 1280. Controller 1280 may have a port configured to be coupled to battery 1255 and to detect an analog signal, such as a measurement of voltage, current, etc., representing a level of battery 1255 or power source, or other analog signal source. Path selector 1201 may close the switch based on a third control signal generated by controller 1280. The closed switch may close the circuit of battery 1255 and controller 1280, and controller 1280 may detect an analog signal representing a level of battery 1255. In another example, path selector 1201 may comprise a switch, e.g., a single-pole-single-throw switch, configured to be coupled to memory 1257 and controller 1280. Controller 1280 may have a port configured to be coupled to memory 1257 and to receive data from memory 1257. Path selector 1201 may close the switch based on a third control signal generated by controller 1280. The closed switch may close the circuit of memory 1257 and controller 1280, and controller 1280 may retrieve a flag or other data representing a status of end device 1274 from memory 1257. A status may be a setting of end device 1274, for example, a range of the volume setting of end device 1274 (e.g., end device 1274 has twenty-four different volume levels), a current level of the volume setting of end device 1274 (e.g., level 10), a color of end device 1274, an identifier of a build or application installed or running on end device 1274, whether an application (e.g., noise cancellation) is being activated, and the like.

Similar to controller 180 of FIGS. 2-3 and 9-10, controller 1280 may receive response data signals from host devices 1272-1273 and end device 1274. The response data signals may be received at connector 1264, then routed to connectors 1262-1263 by path selector 1201, then transmitted to controller 1280 by host devices 1272-1273. In one example, the response data signal received at connector 1264 may not include information on the level of battery 1255 or a status of end device 1274. For example, an end device 1274 with no operation system or other system software may not generate data representing information associated with battery 1255 or memory 1257 that may be transmitted through connector 1264. Here, controller 1280 may detect an analog signal representing a level of battery 1255 by using a direct connection, e.g., a wire, to battery 1255 through path selector 1201, and may retrieve data from memory 1257 by using a direct connection, e.g., a wire, to memory 1257 through path selector 1201. Controller 1280 may also store data representing the level of battery 1274 or data representing a status of end device 1274 in a test repository or other memory coupled to controller 1280. Controller 1280 may transmit data representing the level of battery 1274 or data representing a status of end device 1274 to another device in data communication with controller 1280. Controller 1280 may determine whether end device 1274 is functioning properly based on data representing the level of battery 1255 or data representing a status of end device 1274, or perform other analyses. For example, controller 1280 may have a memory storing expected values for the response data signals, data representing the level of battery 1255, and data representing a status of end device 1274 retrieved from memory 1257. Controller 1280 may compare the expected values with the received or detected values to determine whether end device 1274 is functioning properly.

In one example, controller 1280 may generate a first control signal to route data between connector 1262 and 1264, and generate a second control signal to cause transmission of a data signal, e.g., a USB-formatted data signal, from host device 1272 to end device 1274. The USB-formatted data signal may initiate installation of software, e.g., Software #n, on end device 1274. Software #n may change the range of volume settings of end device 1274 from seventeen to twenty-four, so that there are now twenty-four levels in the volume setting. Controller 1280 may generate a third control signal to close a path coupled to memory 1257. Controller 1280 may then retrieve a flag from memory 1257, the flag representing the number of levels in the volume setting. Controller 1280 may then store the flag in a test repository. Controller 1280 may then compare the expected value based on Software #n with the actual value retrieved from memory 1257 and determine whether end device 1274 is functioning properly or whether Software #n was installed. In another example, controller 1280 may generate the first control signal and the second control signal to cause installation of Software #n on end device 1274, as described above. Controller 1280 may generate a third control signal to close a path coupled to battery 1255. Controller 1280 may detect a level of the battery at a predetermined time internal, e.g., every 30 minutes. Controller 1280 may also determine when a level of battery falls below a threshold level, e.g., 10% of the full level of the battery. Based on statistics and analyses such as these, controller 1280 may determine whether Software #n causes an increased drainage of battery 1255 or shortens battery life.

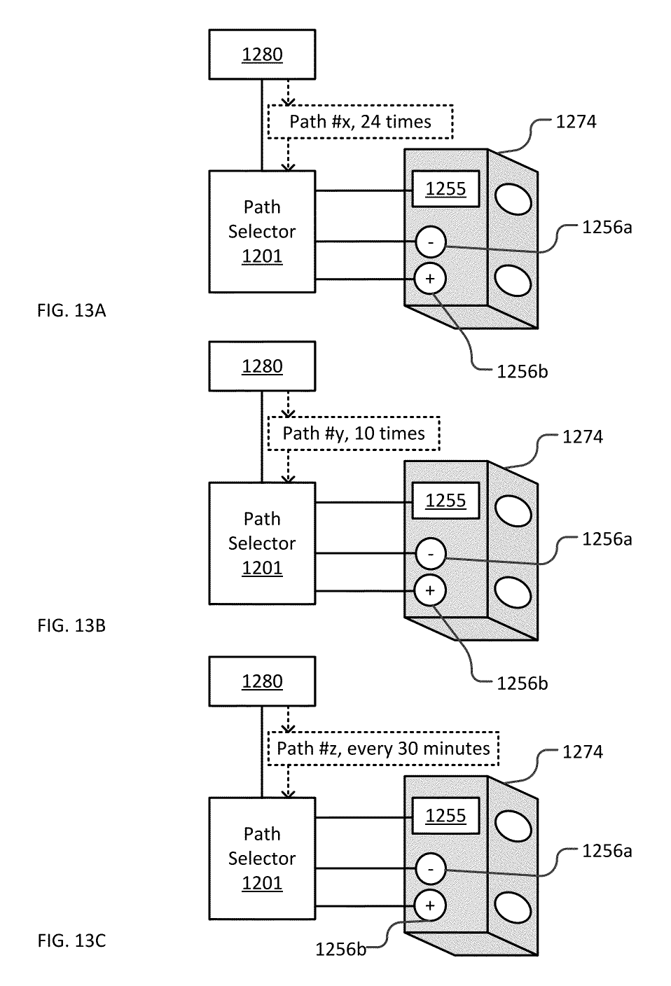

The hardware interface selector in FIG. 12 may also be used for testing, accessibility and other purposes. For example, a testing application may be configured to test the life of a battery while media device 1274 is playing an audio file at different volume levels (see FIGS. 13A-C). As another example, an alternate command signal, e.g., an audio or voice command, may be used to generate an electrical signal representing a closing of mechanical switch 1256. Other implementations of the hardware interface selector may also be possible.

FIG. 13A-C illustrates an application of an exemplary hardware interface selector with an end device in some applications, according to some examples. Similarly-named and/or similarly-numbered elements shown in FIG. 12 may at least include similar or equivalent structures and/or functions. Here, a hardware interface selector (not shown) comprises a path selector 1201 and a controller 1280. Path selector 1201 may comprise one or more path selectors or switches. Path selector 1201 may be coupled to battery 1255 and mechanical switches 1256a and 1256b of end device 1274. In one example, one compression or closing of mechanical switch 1256a may decrease the volume setting of end device 1274 by one level, and one compression or closing of mechanical switch 1256b may increase the volume setting of end device 1274 by one level. In one example, Path #x may be coupled to mechanical switch 1256a, Path #y may be coupled to mechanical switch 1256b, and Path #z may be coupled to battery 1255. For example, when path selector 1201 closes Path #z based on a control signal generated by controller 1280, this may close or connect the circuit between controller 1280 and battery 1255, and controller 1280 may detect a level of battery 1255.

In one example, the hardware interface selector may be configured to evaluate information associated with battery 1255 when the volume setting is set to a certain level, e.g., level 10. For example, end device 1274 has twenty-four levels in its volume setting. In FIG. 13A, controller 1280 may generate a control signal to close Path #x coupled to mechanical switch 1256a twenty-four times, generating an electrical signal representing a closing of mechanical switch 1256a twenty-four times. Here, the level of the volume setting may decrease twenty-four times, and this may ensure that the volume setting is set to level 0. In FIG. 13B, controller 1280 may then generate a control signal to close Path #y coupled to mechanical switch 1256b ten times, generating an electrical signal representing a closing of mechanical switch 1256b ten times. Here, this may set the volume setting to level 10. In FIG. 13C, controller 1280 may then generate a control signal to close Path #z coupled to battery 1255 at a preset time internal, e.g., every 30 minutes. Controller 1280 may store the data representing the level of battery 1255 every 30 minutes in a test repository. Controller 1280 may compare the level of battery 1255 every 30 minutes with other data sets generated from different end devices. Controller 1280 may present information associated with battery 1255 when the volume setting is set to a certain level at a user interface.

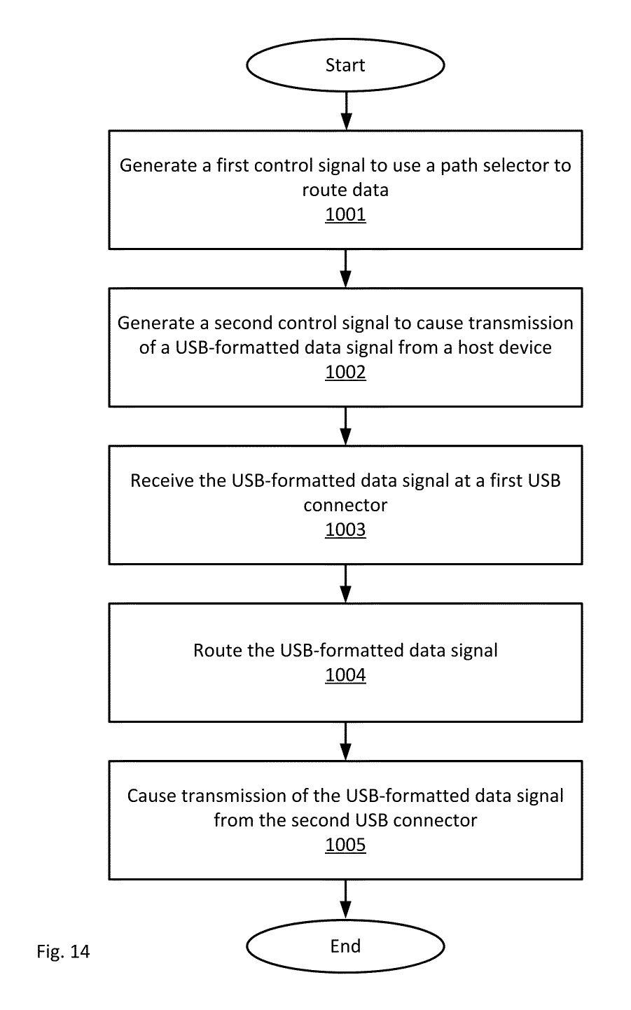

FIG. 14 illustrates an exemplary process for a hardware interface selector, according to some examples. At 1001, a first control signal to use a path selector of a hardware interface selector to route data between a plurality of pole contacts and a subset of a plurality of throw contacts may be generated. In one example, while data is being routed between a plurality of pole contacts and a subset of a plurality of throw contacts, data may not be routed between the plurality of pole contacts and the other subset of the plurality of throw contacts. In one example, the path selector may comprise a single-pole-dual-throw switch. At 1002, a second control signal to cause transmission of a data signal from a host device to one end device of a plurality of end devices may be generated. The data signal may be a USB-formatted data signal or other data signal. In one example, a plurality of end devices may be coupled to the hardware interface selector. In one example, when a data signal is being transmitted from the host device to one end device of the plurality of end devices, the data signal is not being transmitted from the host device to the other end devices of the plurality of end devices. At 1003, the data signal may be received at a first connector, e.g., a first USB connector, which may be coupled to the plurality of pole contacts. At 1004, the data signal may be routed from the plurality of pole contacts to the subset of the plurality of throw contacts based on the first control signal, and the subset of the plurality of throw contacts may be coupled to a second connector, e.g., a second USB connector. At 1005, transmission of the data signal from the second connector to the one end device may be caused or initiated. The second connector may be coupled to the one end device. The data signal may cause execution of an operation of the end device, e.g., performing a function of the end device, installing a software on the end device. Still, other implementations may be possible. In other examples, the steps may be varied, and the sequence of the steps may be varied, and other processes may be performed.

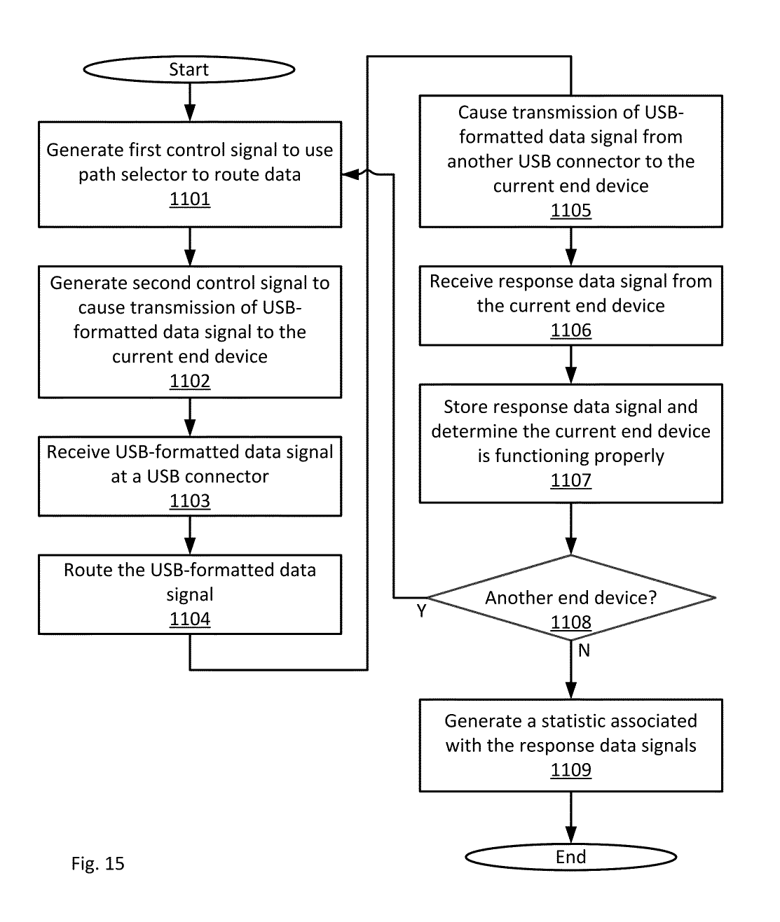

FIG. 15 illustrates another exemplary process for a hardware interface selector, according to some examples. At 1101, a first control signal to use a path selector of a hardware interface selector to route data between a plurality of pole contacts and a subset of a plurality of throw contacts may be generated. At 1102, a second control signal to cause transmission of a data signal, e.g., a USB-formatted data signal, from a host device to an end device may be generated. In one example, a plurality of end devices may be coupled to the hardware interface selector. At 1103, the data signal may be received at a first connector, e.g., a first USB connector, coupled to the plurality of pole contacts. At 1104, the data signal may be routed from the plurality of pole contacts to the subset of the plurality of throw contacts based on the first control signal, and the subset of the plurality of pole contacts may be coupled to a second connector, e.g., a second USB connector. At 1105, transmission of the data signal from the second connector to the end device may be caused or initiated. At 1106, a response data signal may be received from the end device. The response data signal may include information indicating whether the data signal was transmitted from the host device to the end device, a status of the end device, and the like. The response data signal may be received at the second connector, and may be routed to the first connector using the path selector based on the first control signal. Transmission of the response data signal from the first connector to the host device may be caused or initiated. The response data signal may be received at the controller or processor of the hardware interface selector from the host device. At 1107, the hardware interface selector may store the response data signal in a test repository or other memory (local or remote), and may determine whether the end device is functioning properly based on the response data signal. For example, the data signal may initiate installation of new software on the end device, and the response data signal may be a signal representing that the new software was installed on the end device. As another example, the hardware interface selector may have a memory (local or remote) storing expected values or templates of response data signals based on the data signal transmitted to the end device due to the first control signal. Different expected values or templates may be provided for different data signals. The hardware interface selector may compare the response data signal received from the host device and the end device with one or more expected values or templates. If there is a match, or a match within a certain tolerance, then the hardware interface selector may determine that the end device is functioning properly. At 1108, a query may be made as to whether there is another end device to test or to run an operation on. If yes, the process may go through 1101 to 1107 on the other end device. At 1107, a response data signal from the other end device may be stored and analyzed. The process can continuously be run on numerous devices. If no, at 1109, the hardware interface selector may generate a statistic or other information associated with the response data signals received from one or more end devices that were tested or operated on. For example, the hardware interface selector may calculate a percentage of end devices that are functioning properly. The hardware interface may calculate a statistic correlating which end devices are functioning properly with a build that is used by the end device. Other statistics and information may also be generated. In other examples, the steps may be varied, and the sequence of the steps may be varied, and other processes may be performed.

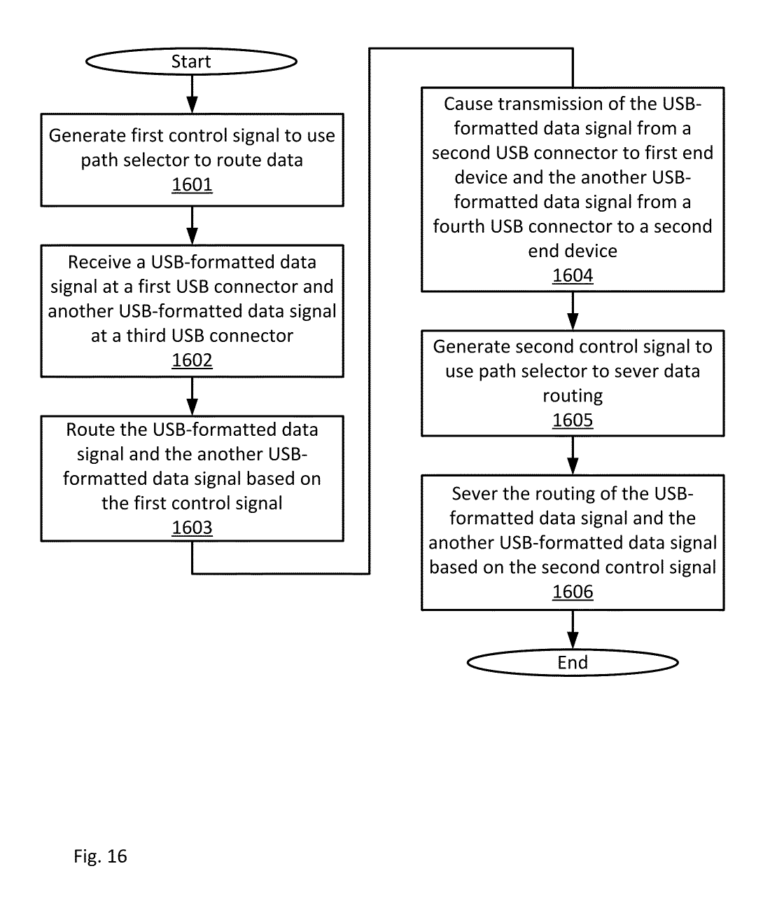

FIG. 16 illustrates another exemplary process for a hardware interface selector, according to some examples. At 1601, a first control signal to use a path selector of a hardware interface selector to route data between a first subset of contacts and a second subset of contacts and between a third subset of contacts and a fourth subset of contacts may be generated. In one example, data may be routed between a first subset of contacts and a second subset of contacts and data may be routed between a third subset of contacts and a fourth subset of contacts simultaneously or successively. In one example, the first subset of contacts and the third subset of contacts may be pole contacts, and the second subset of contacts and the fourth subset of contacts may be throw contacts. In one example, the path selector may comprise a single-pole-single-throw switch. At 1602, a data signal, e.g., a USB-formatted data signal, may be received from a host device at a first connector, e.g., a first USB connector, of the hardware interface selector, and the first connector may be coupled to the first subset of contacts, and another data signal, e.g., another USB data signal, may be received from the host device at a third connector, e.g., a third USB connector, of the hardware interface selector, and the third connector may be coupled to the third subset of contacts. At 1603, the data signal may be routed from the first subset of contacts to the second subset of contacts and the another data signal may be routed from the third subset of contacts to the fourth subset of contacts based on the first control signal. The second subset of contacts may be coupled to a second connector, e.g., a second USB connector, of the hardware interface selector, and the fourth subset of contacts may be coupled to a fourth connector, e.g., a fourth USB connector, of the hardware interface selector. At 1604, transmission of the data signal from the second connector to a first end device may be caused and transmission of the another data signal from the fourth connector to a second end device may be caused. The data signal and the another data signal may be configured to cause execution of an operation of the first end device and the second end device, respectively. For example, the data signal may transmit information used for identifying, configuring or enumerating the first end device. As another example, the data signal may transit information used for installing software or performing another operation of the first end device. As another example, the data signal may cause the first end device to establish a data connection or communication link (wired or wireless) with a second end device. At 1605, a second control signal to use the path selector to sever data routing between the first subset of contacts and the second subset of contacts and between the third subset of contacts and the fourth subset of contacts may be generated. At 1606, the routing of the data signal from the first subset of contacts to the second subset of contacts and of the another data signal from the third subset of contacts to the fourth subset of contacts may be severed based on the first control signal. Once severed, the first end device and the second end device may be reset, or the host device may detect that the first end device and the second end device have been detached, or other operations may also be performed. In one example, a third control signal to use a path selector of a hardware interface selector to route data between a first subset of contacts and a second subset of contacts and between a third subset of contacts and a fourth subset of contacts again may be generated.

In one example, the data signal received by the first end device may cause the first end device to establish a data connection with the second end device. The second end device may generate a response data signal in response to the data connection with the first end device. The response data signal may be received from the second end device at the fourth connector and received at the fourth subset of contacts. The response data signal may be routed from the fourth subset of contacts to the third subset of contacts and received at the third connector. Transmission of the response data signal from the third connector to the host device may be caused. The response data signal may be received, stored, and analyzed by the hardware interface selector. In other examples, the steps may be varied, and the sequence of the steps may be varied, and other processes may be performed.

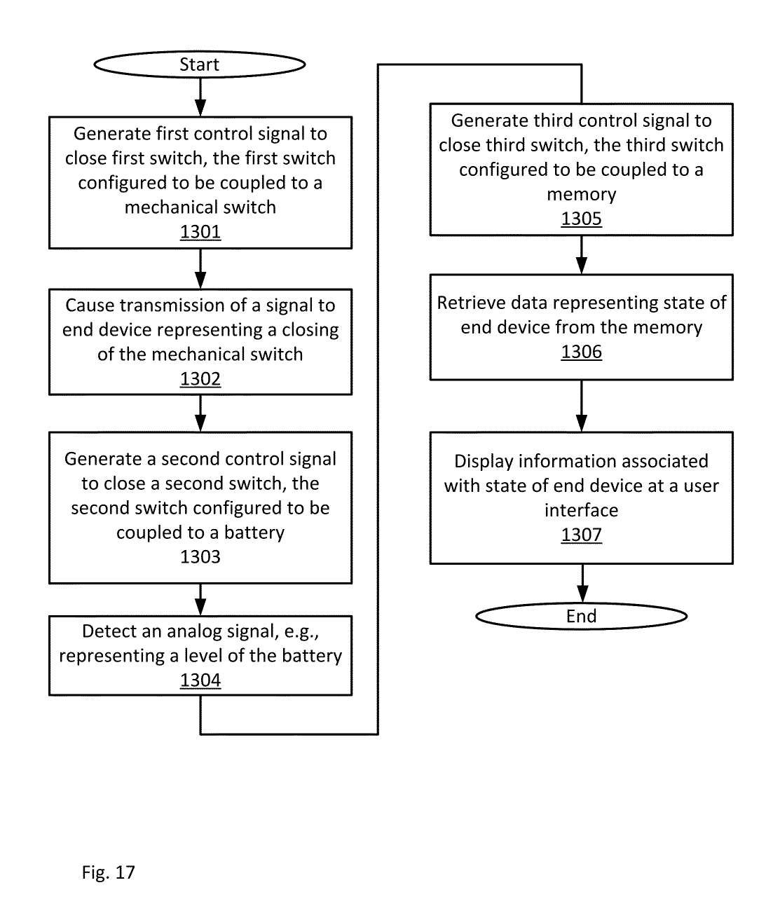

FIG. 17 illustrates another exemplary process for a hardware interface selector, according to some examples. At 1301, a first control signal to close a first switch of a hardware interface selector may be generated, and the first switch may be configured to be coupled to a mechanical switch of an end device. At 1302, after generating the first control signal, transmission of an electrical signal representing a closing of the mechanical switch to the end device is caused. At 1303, a second control signal to close a second switch of the hardware interface selector may be generated, and the second switch may be configured to be coupled to a battery of an end device. At 1304, after generating the second control signal, an analog signal representing a level of the battery is detected. At 1305, a third control signal to close a third switch of the hardware interface selector may be generated, and the third switch may be configured to be coupled to a memory of the end device. At 1306, after generating the third control signal, data representing a state of the end device may be retrieved from the memory. At 1307, information associated with the state of the end device may be presented at a user interface. The user interface may be local or remote to the hardware interface selector. For example, the state of the end device may be associated with a volume setting of the end device, a memory capacity of the end device, a color or manufacturer of the end device, a build number of the end device, and the like. In other examples, the steps may be varied, and the sequence of the steps may be varied, and other processes may be performed.

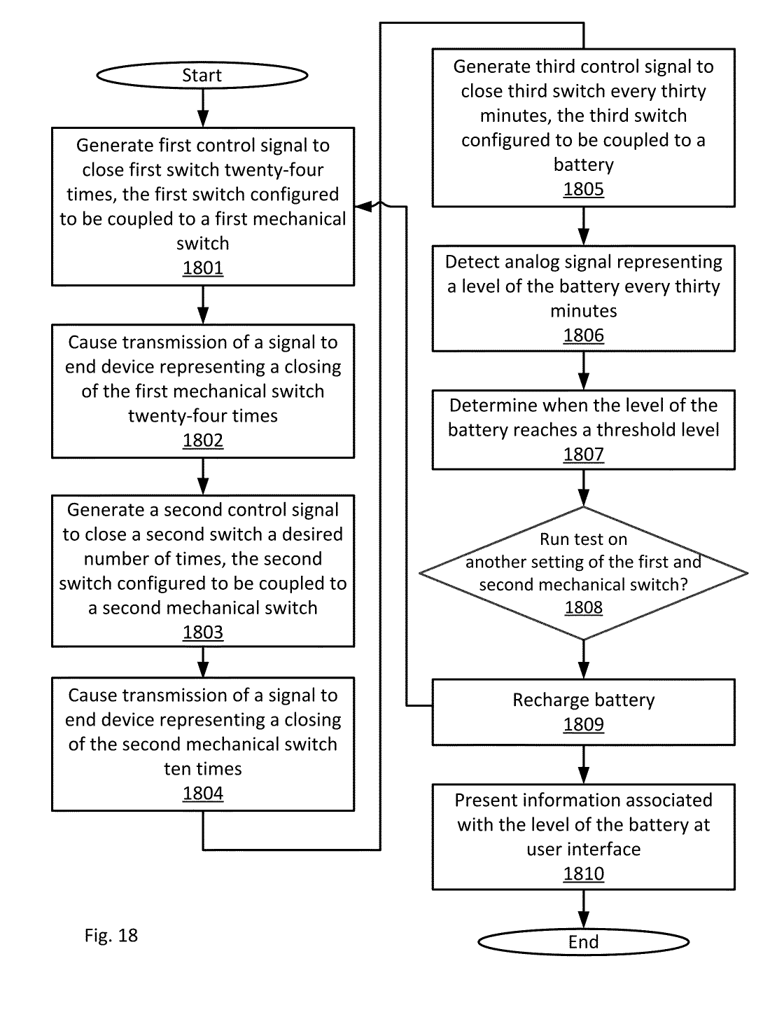

FIG. 18 illustrates another exemplary process for a hardware interface selector, according to some examples. At 1801, a first control signal to close a first switch of a hardware interface selector may be generated a specified number of times, e.g., twenty-four times, and the first switch may be configured to be coupled to a first mechanical switch of an end device. In one example, the range of the volume settings of the end device is twenty-four, and closing the first switch twenty-four times may ensure that the volume setting is set to one end of the range. At 1802, transmission of an electrical signal representing a closing of the first mechanical switch to the end device may be caused twenty-four times. At 1803, a second control signal to close a second switch of a hardware interface selector may be generated a specified number of times, e.g., ten times, and the second switch may be configured to be coupled to a second mechanical switch of the end device. At 1804, transmission of an electrical signal representing a closing of the second mechanical switch to the end device may be caused ten times. At 1805, a third control signal to close a third switch of a hardware interface selector may be generated a specified number of times or at a specified frequency, e.g., every thirty minutes, and the third switch may be configured to be coupled to a battery of the end device. At 1806, an analog signal representing a level of the battery may be detected at the specified frequency, e.g., every thirty minutes. At 1807, the time when the level of the battery reaches a threshold level, e.g., 10% of the full level of battery, may be determined, and may be stored in a memory coupled to the hardware interface selector. At 1808, a query may be made as to whether to run a test on another setting controlled by or associated with the first mechanical switch and the second mechanical switch, e.g., another volume level. If yes, at 1809, the battery is recharged, and the process goes through 1801-1807, except that the first switch and the second switch may be closed a different number of times. The battery may be recharged by closing the third switch, which is coupled to the battery, based on another control signal. Other methods for recharging the battery may also be used. If no, at 1810, information associated with the level of the battery is presented at a user interface. In other examples, the steps may be varied, and the sequence of the steps may be varied, and other processes may be performed.

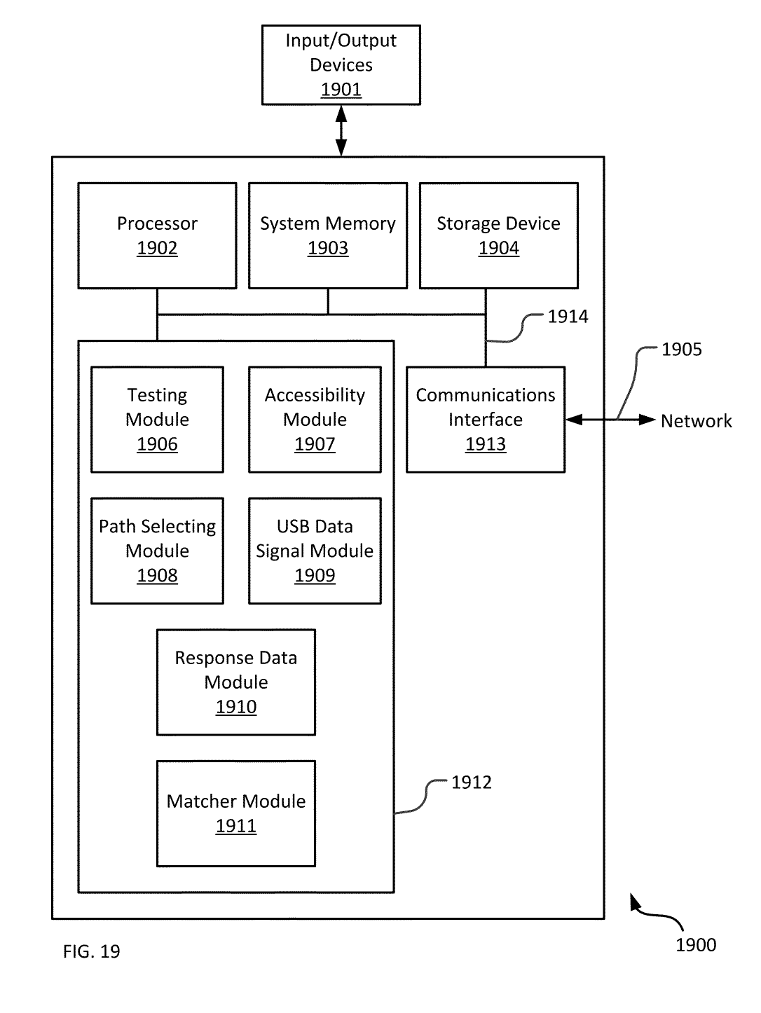

FIG. 19 illustrates an exemplary computing platform of an exemplary hardware interface selector in some applications, according to some examples. In some examples, computing platform 1900 may be used to implement computer programs, applications, methods, processes, algorithms, or other software to perform the above-described techniques. Computing platform 1900 includes a bus 1914 or other communication mechanism for communicating information, which interconnects subsystems and devices, such as processor 1902, system memory 1903 and 1912 (e.g., RAM, etc.), storage device 1904 (e.g., ROM, etc.), a communications interface 1913 (e.g., an Ethernet or wireless controller, a Bluetooth controller, etc.) to facilitate communications via a port on communication link 1905 to communicate, for example, with a computing device, including mobile computing and/or communication devices with processors. Processor 1902 can be implemented with one or more central processing units (“CPUs”), such as those manufactured by Intel® Corporation, or one or more virtual processors, as well as any combination of CPUs and virtual processors. Computing platform 1900 exchanges data representing inputs and outputs via input-and-output devices 1901, including, but not limited to, keyboards, mice, audio inputs (e.g., speech-to-text devices), user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like.

According to some examples, computing platform 1900 performs specific operations by processor 1902 executing one or more sequences of one or more instructions stored in system memory 1912, and computing platform 1900 can be implemented in a client-server arrangement, peer-to-peer arrangement, or as any mobile computing device, including smart phones and the like. Such instructions or data may be read into system memory 1912 from another computer readable medium, such as storage device 1904. In some examples, hard-wired circuitry may be used in place of or in combination with software instructions for implementation. Instructions may be embedded in software or firmware. The term “computer readable medium” refers to any tangible medium that participates in providing instructions to processor 1902 for execution. Such a medium may take many forms, including but not limited to, non-volatile media and volatile media. Non-volatile media includes, for example, optical or magnetic disks and the like. Volatile media includes dynamic memory, such as system memory 1912.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1914 for transmitting a computer data signal.

In some examples, execution of the sequences of instructions may be performed by computing platform 1900. According to some examples, computing platform 1900 can be coupled by communication link 1905 (e.g., a wired network, such as LAN, PSTN, or any wireless network) to any other processor to perform the sequence of instructions in coordination with (or asynchronous to) one another. Computing platform 1900 may transmit and receive messages, data, and instructions, including program code (e.g., application code) through communication link 1905 and communication interface 1913. Received program code may be executed by processor 1902 as it is received, and/or stored in memory 1903 or 1912 or other non-volatile storage for later execution.

In the example shown, system memory 1912 can include various modules that include executable instructions to implement functionalities described herein. In the example shown, system memory 1912 includes a testing module 1906, an accessibility module 1907, a path selecting module 1908, a USB data signal module 1909, a response data module 1910, and a matcher module 1911.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A device, comprising:
a first path selector configured to be coupled to a mechanical switch of an end device, the mechanical switch configured to generate a signal representing a user input;
a second path selector configured to be coupled to a battery of the end device;
a third path selector configured to be coupled to a memory of the end device; and
a controller configured to generate a first control signal, a second control signal and a third control signal, the first control signal configured to close the first path selector to generate an electrical signal representing a closing of the mechanical switch, the second control signal configured to close the second path selector to cause detection of an analog signal representing a level of the battery, and the third control signal configured to close the third path selector to cause retrieval of data representing a state of the end device from the memory.

2. The device of claim 1, wherein the controller is further configured to determine a time when the level of the battery reaches a threshold level.

3. The device of claim 1, wherein the state of the end device comprises a level of a volume setting of the end device, and the controller is further configured to determine whether the end device is functioning properly based on the state of the end device.

4. The device of claim 1, wherein the state of the end device comprises a color of the end device.

5. The device of claim 1, wherein the controller is further configured to retrieve data representing a build identifier of the end device from the memory.

6. The device of claim 1, wherein the first path selector is a single-pole-single-throw switch.

7. The device of claim 1, wherein the first path selector is a single-pole-dual-throw switch.

8. The device of claim 1, wherein the level of the battery is inaccessible using a connector of the end device.

9. A method, comprising:
generating a first control signal to close a first path selector configured to be coupled to a mechanical switch of an end device, the mechanical switch configured to generate a signal representing a user input;
causing transmission of an electrical signal representing a closing of the mechanical switch to the end device after generating the first control signal;
generating a second control signal to close a second path selector configured to be coupled to a battery of the end device;
detecting an analog signal representing a level of the battery after generating the second control signal;
generating a third control signal to close a third path selector configured to be coupled to a memory of the end device;
retrieving data representing a state of the end device from the memory after generating the third control signal; and
displaying information associated with the state of the end device at a user interface.

10. The method of claim 9, further comprising:
generating a fourth control signal to close the first path selector for a first number of times, the first number of times being equal to or greater than a range associated with the mechanical switch;
generating a fifth control signal to close a fourth path selector for a second number of times, the fourth path selector configured to be coupled to another mechanical switch of the end device; and
determining whether the state of the end device matches an expected state associated with generating the fifth control signal for the second number of times.

11. The method of claim 9, further comprising:
generating a fourth control signal to close the first path selector for a first number of times, the first number of times being equal to or greater than a range associated with the mechanical switch;
generating a fifth control signal to close a fourth path selector for a second number of times, the fourth path selector configured to be coupled to another mechanical switch of the end device; and
detecting the analog signal representing the level of the battery at a predetermined frequency.

12. The method of claim 9, wherein the state of the end device comprises a level of a volume setting of the end device, and further comprising determining whether the end device is functioning properly based on the state of the end device.

13. The method of claim 9, further comprising retrieving data representing a build identifier of the end device from the memory.

14. The method of claim 9, further comprising receiving an alternate command signal at the user interface.

15. The method of claim 9, wherein the electrical signal representing a closing of the mechanical switch is configured to cause execution of an operation of the end device.

16. A device, comprising:
a first path selector configured to route data between a first subset of contacts and a second subset of contacts based on a first control signal and to route data between the first subset of contacts and a third subset of contacts based on a second control signal;
a first USB connector coupled to the first subset of contacts, the first USB connector configured to exchange a USB-formatted data signal with a first host device;
a second USB connector coupled to the second subset of contacts, the second USB connector configured to exchange the USB-formatted data signal with a second host device;
a third USB connector coupled to the third subset of contacts, the third USB connector configured to exchange the USB-formatted data signal with an end device;
a second path selector configured to be coupled to a mechanical switch of the end device and configured to form a closed path to generate an electrical signal representing a closing of the mechanical switch based on a third control signal, the mechanical switch configured to generate a signal representing a user input; and
a controller configured to generate the first control signal, the second control signal and the third control signal.

17. The device of claim 16, wherein:
the first subset of contacts comprise a first contact, a second contact, a third contact and a fourth contact;
the first contact is coupled to a first data pin of the first USB connector;
the second contact is coupled to a second data pin of the first USB connector;
the third contact is coupled to a ground pin of the first USB connector; and
the fourth contact is coupled to a voltage supply pin of the first USB connector.

18. The device of claim 16, wherein the controller is further configured to receive a response data signal from the end device, and to determine whether end device is functioning properly based on the response data signal.

19. The device of claim 16, wherein the end device comprises a speaker and the mechanical switch is configured to control a volume of an audio signal generated by the speaker.

20. The device of claim 16, wherein the mechanical switch is configured to control a power supplied to the end device.
